(19) United States
(12) Patent Application Publication
(10) Pub. No.: US 2013/0221099 A1
(43) Pub. Date: Aug. 29, 2013

(54) INFORMATION PROCESSING DEVICE, INFORMATION PROCESSING METHOD AND COMPUTER READABLE STORAGE MEDIUM

(71) Applicant: CASIO COMPUTER CO., LTD., (US)

(72) Inventor: Toru KITAGAWA, Tokyo (JP)

(73) Assignee: CASIO COMPUTER CO., LTD., Tokyo (JP)

(21) Appl. No.: 13/754,508

(22) Filed: Jan. 30, 2013

(30) Foreign Application Priority Data
Feb. 27, 2012 (JP) 2012-040194
Nov. 30, 2012 (JP) 2012-262517

(51) Int. Cl. G06K 7/00

(52) U.S. Cl. CPC G06K 7/0004
USPC 235/440

(57) ABSTRACT

An information processing device is provided with plural reading units, an inclination detection section, a selection section, a control section and a processing section. The reading units are equipped to read plural identifiers with different reading systems. The inclination detection section detects an inclination of a body of the device. The selection section selects one reading unit from the plural reading units in accordance with the inclination of the device body detected by the inclination detection section. The control section causes the identifiers to be read by the reading units selected by the selection section. The processing section processes information of the identifiers that have been read by the reading units.

This application is based on and claims the benefit of priorities from Japanese Patent Application No. 2012-040194, filed on 27 Feb. 2012, and Japanese Patent Application No. 2012-262517, filed on 30 Nov. 2012, the contents of which are incorporated herein by reference.

### BACKGROUND OF THE INVENTION

1. Field of the Invention

The present invention relates to an information processing device, an information processing method and a computer readable storage medium.

2. Related Art

Heretofore, identifiers such as barcodes, radio frequency identification (RFID) tags and the like have been applied to cardboard boxes and the like that go through inspection operations, inventory operations and the like.

Hence, operators may easily identify the cardboard boxes and the like by reading the identifiers applied to the cardboard boxes and the like using portable terminals, which are referred to as readers.

Often, large numbers of these cardboard boxes are gathered in a warehouse or the like. Often, the identifiers applied to a large number of cardboard boxes are not limited to one type but are mixed together in a variety of types.

Accordingly, a portable terminal is provided with plural dedicated reading units for reading each of the plural types of identifier.

A device is provided (for example, see Japanese Unexamined Patent Publication (JP-A) Nos. 2011-48599, 2008-242828 and 2011-22623) that detects an inclination of a terminal, corrects reading data on the basis of the detected inclination, and generates trigger signals for starting an operation and the like.

However, if the technology recited in JP-A No. 2011-48599, JP-A No. 2008-242828 or JP-A No. 2011-22623 is applied to a conventional portable terminal, reading of an identifier may not be conducted properly unless the identifier is read with the portable terminal having been switched to the reading unit that conducts reading in accordance with the type of identifier to be read. Therefore, a human operator must select the reading units in accordance with the respective types of identifier attached to objects, and burdens on the operator are increased.

### SUMMARY OF THE INVENTION

An object of the present invention is to make operations by operators more efficient regardless of types of identifiers.

The information processing device of the present invention includes: a plurality of reading units provided to be capable of reading each of a plurality of types of identifier that differ in reading systems; an inclination detection section that detects an inclination of a body of the device; a selection section that selects one reading unit from the plurality of reading units in accordance with the inclination of the device body detected by the inclination detection section; a control section that causes identifiers of one type to be read by the reading unit selected by the selection section; and a processing section that processes information of the identifiers read by the reading unit.

The computer readable storage medium of the present invention is a non-transitory computer readable medium having stored therein a program executable by a computer for causing the computer to execute a process including: detecting an inclination of a body of a device; selecting one reading unit from a plurality of reading units, which are provided to be capable of reading each of a plurality of types of identifier that differ in reading systems, in accordance with the detected inclination of the device body; causing identifiers of one type to be read by the selected reading unit; and processing information of the identifiers that are read.

According to the present invention, operations by operators may be made more efficient irrespective of types of identifiers.

### BRIEF DESCRIPTION OF THE DRAWINGS

FIG. 1 is a perspective view showing external structures of an image processing device in accordance with a first embodiment of the present invention;

FIG. 2 is a side view showing an inclination of a device body structuring the information processing device according to FIG. 1;

FIG. 3 is a block diagram showing hardware structures of the image processing device in accordance with the first embodiment of the present invention;

FIG. 4 is a view showing a usage example, of barcode scanning of a barcode attached to an object, using the information processing device of FIG. 1;

FIG. 5 is a view showing a usage example, of RFID scanning of an RFID tag attached to an object, using the information processing device of FIG. 1;

FIG. 6 is a view showing a usage example, of barcode scanning and RFID scanning of barcodes and RFID tags attached to a number n of objects plurally placed in a cabinet, using the information processing device of FIG. 1;

FIG. 7 is a functional block diagram showing, of functional structures of the information processing device, functional structures for executing scanning processing;

FIG. 8 is a flowchart describing a flow of scanning processing that is executed by the information processing device of FIG. 1 with the functional structures according to FIG. 7;

FIG. 9 is a flowchart describing details of reading processing in the scanning processing according to FIG. 8;

FIG. 10 is a view showing a usage example, of RFID single scanning of RFID tags respectively attached to objects, using an information processing device in accordance with a second embodiment;

FIG. 11 is a view showing a usage example, of RFID batch scanning of plural RFID tags attached to a single object, using the information processing device of FIG. 1;

FIG. 12 is a view showing a usage example, of RFID batch scanning of plural RFID tags respectively attached to plural objects that are disposed close together, using the information processing device of FIG. 1;

FIG. 13 is a flowchart describing a flow of reading processing in accordance with the second embodiment, which is executed by the information processing device of FIG. 1 equipped with the functional structures of FIG. 7;

FIG. 14 is a flowchart describing a flow of reading processing in accordance with a third embodiment, which is executed by the information processing device of FIG. 1 equipped with the functional structures of FIG. 7;

FIG. 15 is the flowchart describing the flow of the reading processing in accordance with the third embodiment that is executed by the information processing device of FIG. 1 equipped with the functional structures of FIG. 7;

FIG. 16 is a side diagram showing inclinations of the device body structuring the information processing device of FIG. 1;

FIG. 17 is a view showing a state in which the device body structuring the information processing device according to FIG. 1 is tilting from a first state to a second state;

FIG. 18 is a flowchart describing a flow of reading processing in accordance with a fourth embodiment, which is executed by the information processing device of FIG. 3 equipped with the functional structures of FIG. 7; and

FIG. 19 is the flowchart describing the flow of the reading processing in accordance with the fourth embodiment that is executed by the information processing device of FIG. 3 equipped with the functional structures of FIG. 7.

### DETAILED DESCRIPTION OF THE INVENTION

In the following, embodiments of the present invention are explained using the attached drawings.

In a number of embodiments of the present invention that are described below, identifiers are attached (applied) to cardboard boxes, merchandise and the like. These items such as cardboard boxes, merchandise and the like to which the identifiers are attached are referred to hereinafter as “objects”.

### First Embodiment

An information processing device 1 according to a first embodiment of the present invention is a portable terminal, such as a handy terminal or the like, that is capable of reading plural arbitrary types of identifiers among identifiers attached to objects; for example, identifiers that are one-dimensional or two-dimensional codes (symbols), known as barcodes, QR Codes (registered trademark) and the like, identifiers that are non-contact ID tags such as RFID tags and the like, and so forth.

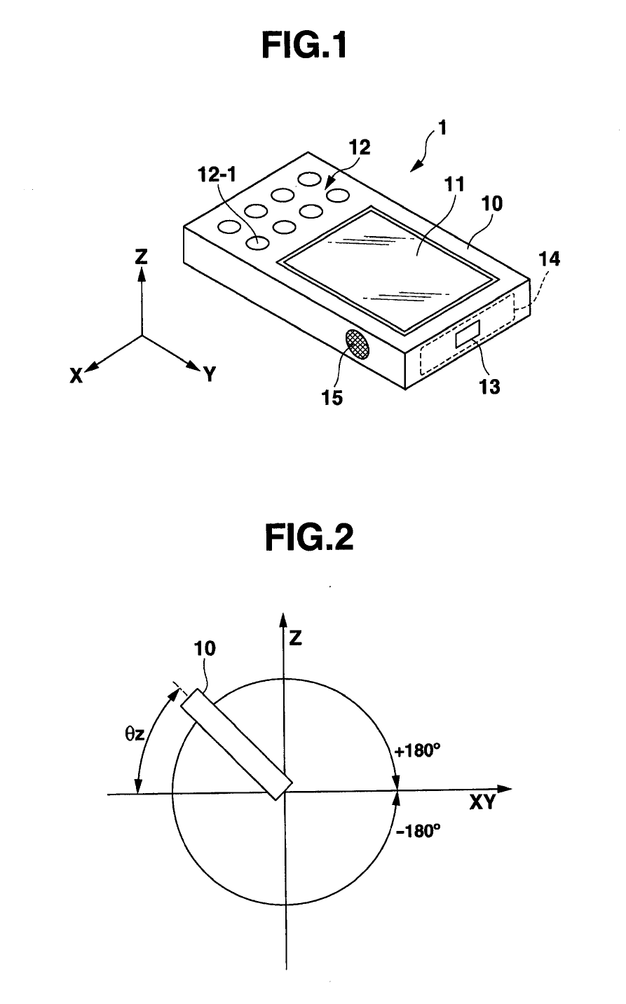

Herebelow, structures of this information processing device 1 are described with reference as appropriate to the drawings from FIG. 1 onward.

FIG. 1 is a perspective view showing external structures of the information processing device 1 according to the first embodiment of the present invention.

The information processing device 1 is equipped with a device body 10, a display section 11, an operation section 12, a code scanner unit 13, an RFID reader/writer unit 14 and a sound output section 15.

The device body 10 has a shape with which an operator may hold the information processing device 1 when reading identifiers such as RFID tags, barcodes and the like that are applied to objects. Specifically, the device body 10 is formed as a casing with a cuboid shape, and accommodates various structural elements that constitute the information processing device 1, which are described below

The display section 11 is structured with a display that is provided at one face of the device body 10, and displays images, text and the like.

Hereinafter, of the faces of the device body 10, the face at which the display section 11 is provided is referred to as “the front face”. Where positional relationships are described hereinafter, the coordinate system shown in FIG. 1 is used.

In the coordinate system in FIG. 1, the X-axis is an axis in one predetermined direction of horizontal directions in three-dimensional real space. The Y-axis is an axis in a direction orthogonal to the X-axis of the horizontal directions in three-dimensional real space. In the example in FIG. 1, a length direction of the front face of the device body 10 coincides with the Y-axis. Of axes in three-dimensional real space, the Z-axis is an axis orthogonal to both the X-axis and the Y-axis.

In the example in FIG. 1, the information processing device 1 is disposed such that the shorter direction of the front face of the device body 10 coincides with the X-axis, the longer direction of the front face of the device body 10 coincides with the Y-axis, and the direction perpendicular to the front face of the device body 10 coincides with the Z-axis.

The operation section 12 is structured with plural buttons, and inputs various kinds of information in accordance with instruction operations of the buttons by an operator.

The code scanner unit 13 scans and captures reading targets (identifiers that are one-dimensional and two-dimensional codes), generates image data, and reads barcodes or two-dimensional codes or the like from the image data. Hereinafter, reading of barcodes, two-dimensional codes and the like with the code scanner unit 13 is referred to as “barcode scanning”.

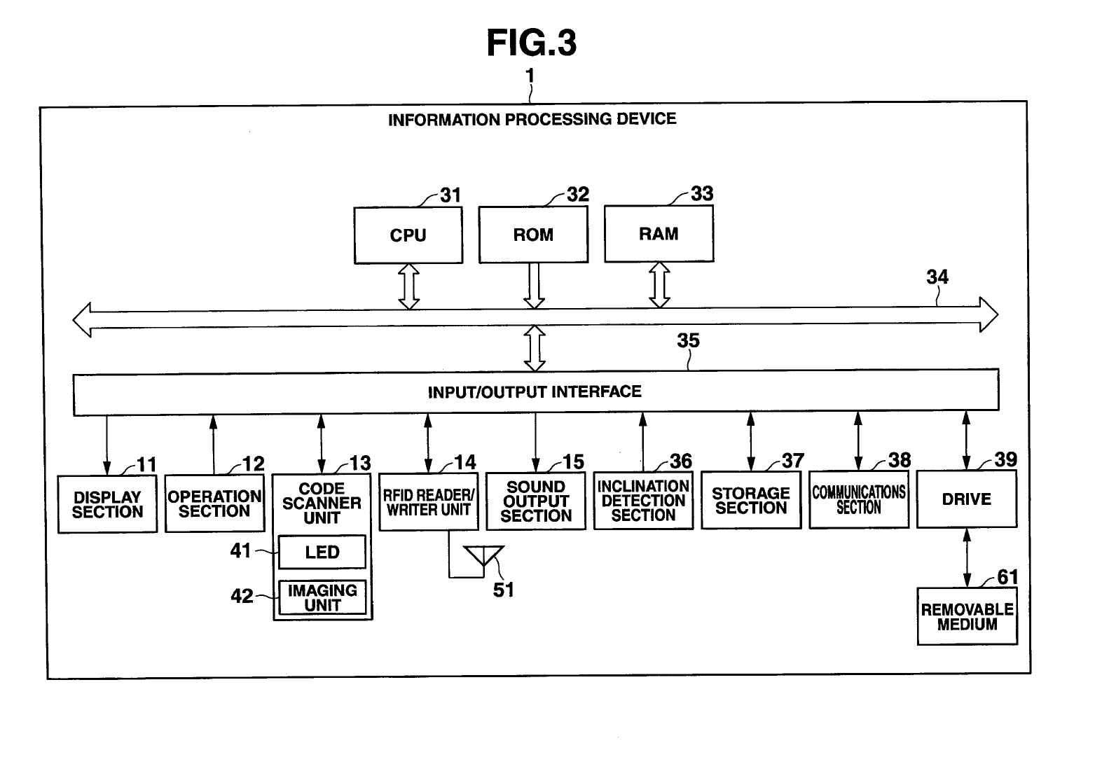

The code scanner unit 13 is formed in a rectangular shape, and is provided along the short direction of the device body 10 at one end of the length direction of the device body 10. Further details of the code scanner unit 13 are described below with reference to FIG. 3.

The RFID reader/writer unit 14 reads and writes information from and to RFID tags. Hereinafter, reading of RFID tags with the RFID reader/writer unit 14 is referred to as RFID scanning.

The RFID reader/writer unit 14 is formed in a rectangular shape, and is provided inside the device body 10 along the short direction of the device body 10 at one end of the length direction of the device body 10. Further details of the RFID reader/writer unit 14 are described below with reference to FIG. 3.

In the present embodiment, an instruction to start reading (scanning) of an identifier is assigned to a button 12-1 of the operation section 12. If the button 12-1 is pressed when the device body 10 is in a first state, barcode scanning is executed by the code scanner unit 13. If the button 12-1 is pressed when the device body 10 is in a second state, RFID scanning is executed by the RFID reader/writer unit 14. Thus, an operator may freely instruct either of barcode scanning by the code scanner unit 13 and RFID scanning by the RFID reader/writer unit 14, just by performing a simple operation of suitably changing a state of the device body 10 between the first state and the second state and pressing the same button 12-1.

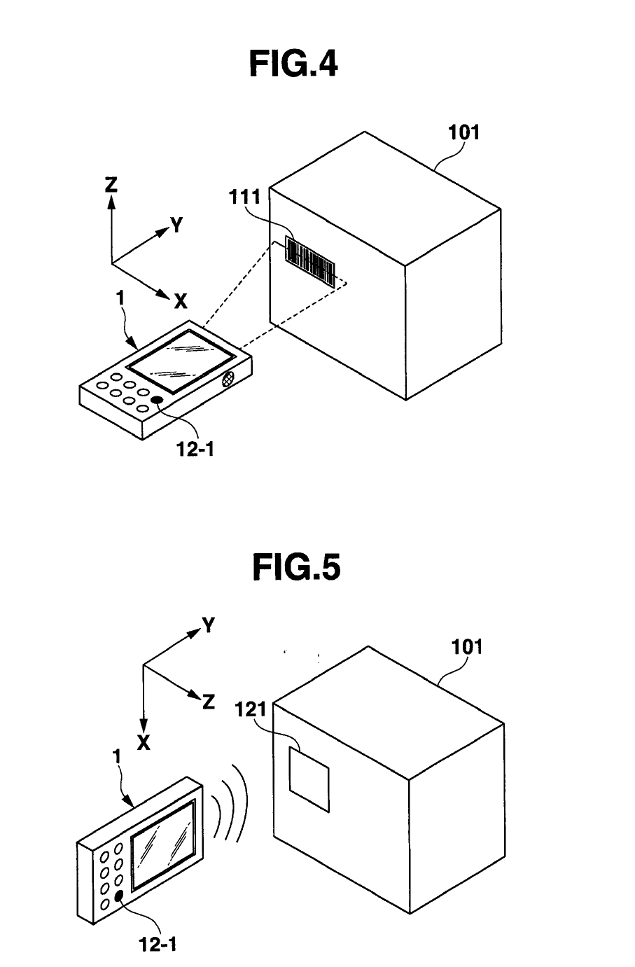

It is sufficient that the first state and the second state be states that are different from one another and that can be changed between by an operation by the operator. Specific examples of the first state and the second state are described below with reference to FIG. 4, FIG. 5 and the like.

The sound output section 15 is structured with a speaker and a buzzer or the like, and outputs various sounds such as warning sounds, effect sounds and the like.

Specifically, the sound output section 15 outputs predetermined sounds when a new reading system by a reading unit—the code scanner unit 13, the RFID reader/writer unit 14 or the like—is selected, when reading is successful, and when reading fails. Thus, the sound output section 15 may provide notifications to the operator.

Next, a state in which the device body 10 of the information processing device 1 is tilted by an operator is described with reference to FIG. 2.

FIG. 2 is a side view showing an inclination of the device body structuring the information processing device according to FIG. 1.

As is described below, while holding the device body 10, an operator performs an operation to read an identifier applied to an object while altering the attitude and direction or the like of the information processing device 1. In such a case, the inclination of the device body 10 is changed, for example, as shown in FIG. 2.

In FIG. 2, a turning angle thetaZ about the Y-axis is a turning angle when, while the operator is holding the device body 10 of the information processing device 1, the operator turns the device body 10 in the left-and-right direction about an axis in the front-and-back direction as seen by the operator. In other words, the extent to which the device body 10 of the information processing device 1 is tilted in the X-Y plane is defined by the turning angle thetaZ.

The turning angle thetaZ is changed by the operator holding, for example, a portion at the operation section 12 end of the device body 10 of the information processing device 1 in their hand and tilting the device body 10 to left or right about their wrist.

In the present embodiment, for ease of understanding, the turning angle thetaZ when the device body 10 is horizontal in the X-Y plane is referred to as 0°, angles when the device body 10 is turned clockwise are referred to as positive (+) angles, and angles when the device body 10 is turned counter-clockwise are referred to as negative (−) angles.

Next, hardware structures of the information processing device 1 in FIG. 1 are described.

FIG. 3 is a block diagram showing the hardware structures of the image processing device 1 in accordance with the first embodiment of the present invention.

In addition to the display section 11, operation section 12, code scanner unit 13, RFID reader/writer unit 14 and sound output section 15 described by reference to FIG. 1, the information processing device 1 is equipped with a central processing unit (CPU) 31, a read-only memory (ROM) 32, a random access memory (RAM) 33, a bus 34, an input/output interface 35, an inclination detection section 36, a storage section 37, a communications section 38 and a drive 39.

The CPU 31 executes various types of processing according to programs that are recorded in the ROM 32 or that are loaded from the storage unit 37 into the RAM 33.

The ROM 32 stores various processing programs. For example, various processing programs for implementing various functions are stored in the ROM 32, such as acquiring angular velocity values outputted by the inclination detection section 36 of the information processing device 1, controlling reading by the code scanner unit 13 or the RFID reader/writer unit 14 on the basis of the angular velocity values, and the like.

As appropriate, the RAM 33 stores data required for execution of the various processes by the CPU 31 and the like, which includes values acquired or generated in processing such as angular velocity values and the like.

The CPU 31, the ROM 32 and the RAM 33 are connected to one another via the bus 34.

The input/output interface 35 is also connected with the bus 34. The input/output interface 35 is connected to the display section 11, the operation section 12, the code scanner unit 13, the RFID reader/writer unit 14, the sound output section 15, the inclination detection section 36, the storage section 37, the communications section 38 and the drive 39.

In accordance with instructions from the CPU 31, the code scanner unit 13 executes barcode scanning of reading targets (one-dimensional and two-dimensional code identifiers). That is, the code scanner unit 13 reads a reading target by imaging the reading target and generating image data. In other words, the code scanner unit 13 may be understood as being a reading unit that detects reading targets by barcode scanning.

The code scanner unit 13 is structured to include a light-emitting diode (LED) unit 41 and an imaging unit 42.

The LED unit 41 is a light source with an LED lamp or the like that emits LED light to serve as illumination light. The LED unit 41 illuminates the LED light onto a reading target (a reading position).

The imaging unit 42 is provided with an imaging component such as a complementary metal oxide semiconductor (CMOS) sensor or the like. The imaging unit 42 images the reading target illuminated with the LED light from the LED unit 41 (optically reads the reading target by photoelectric conversion), and generates image data.

The imaging unit 42 then transfers the generated image data to the RAM 33. The CPU 31 decodes the image data generated by the imaging unit 42, and analyzes information expressed by the two-dimensional code. As the imaging component, a charge coupled device (CCD) may be used instead of a CMOS sensor.

In accordance with instructions from the CPU 31, the RFID reader/writer unit 14 executes RFID scanning of a reading target (an RFID tag). That is, the RFID reader/writer unit 14 supplies electric power to a reading target, being a non-contact power source that uses electromagnetic waves as a medium, and executes reading and/or writing of information and other required processes.

In other words, the RFID reader/writer unit 14 may be understood as being a reading unit that detects a reading target by RFID scanning.

More specifically, when the RFID reader/writer unit 14 is disposed in a range in which non-contact communication with an RFID tag (not shown in the drawings) is possible, a carrier wave is amplitude-modulated in accordance with transmission information from the CPU 31 (a reading command or the like), and the resulting amplitude-modulated wave is radiated as electromagnetic waves from a loop coil (not shown in the drawings) of an antenna 51.

Correspondingly, at the RFID tag (not shown in the drawings), currents are caused to flow in a loop coil in the RFID tag by electromagnetic fields generated by the RFID reader/writer unit 14, and electronic signals are generated. In accordance with detection and demodulation of these electronic signals, the transmitted information is received by a control section in the RFID tag.

Processing based on the transmitted information is executed by the control section in the RFID tag; for example, information is read from or written to a memory.

In a case in which processing to read information is executed, which is to say a case in which information from the memory in the RFID tag or the like is read out to be transmission information, a resonance frequency (impedance) of a resonant circuit formed in the RFID tag is varied in accordance with the transmission information.

The RFID reader/writer unit 14 acquires changes in the resonance frequency as changes in voltage via the antenna 51, and detects and demodulates these voltages. Thus, the RFID reader/writer unit 14 receives the transmission information from the RFID tag (read-out information or the like), and supplies the transmission information to the CPU 31.

The inclination detection section 36 is structured with an angular velocity sensor equipped with, for example, a gyroscope. The inclination detection section 36 detects values of angular velocity of the device body 10 about the Y-axis (hereinafter referred to simply as “angular velocity values”) to serve as inclinations of the device body 10, and outputs the detected angular velocity values to the CPU 31.

In this embodiment, when the CPU 31 acquires angular velocity values outputted from the inclination detection section 36, the CPU 31 controls reading by the code scanner unit 13 and the RFID reader/writer unit 14 on the basis of the angular velocity values.

The CPU 31 also controls outputs from the sound output section 15 in accordance with the angular velocity values. These controls by the CPU 31 are described in more detail below.

The storage section 37 is structured with a hard disc, a dynamic random access memory (DRAM) or the like, and stores data of various types of identifiers.

The communications section 38 controls communications with other devices (not shown in the drawings) over networks, including the Internet.

A removable medium 61 constituted with a magnetic disk, an optical disk, a magneto-optical disk, semiconductor memory, or the like is installed in the drive 39, as appropriate. As required, programs read from the removable medium 61 by the drive 39 are installed in the storage section 37.

Similarly to the storage section 37, the removable medium 61 may also store various kinds of data such as the data on identifiers and the like stored in the storage section 37.

Next, a usage example of the information processing device 1 is described with reference to FIG. 4 to FIG. 6.

FIG. 4 is a view showing a usage example, of barcode scanning of a barcode 111 attached to an object 101, using the information processing device 1 of FIG. 1.

When an operator presses the button 12-1 in a state (the first state) in which the front face of the device body 10 of the information processing device 1 is inclined substantially in a horizontal direction (the horizontal direction in the X-Y plane), the information processing device 1 starts barcode scanning of the barcode 111.

That is, the start of scanning processing is instructed by the operator pressing the button 12-1 in a state in which the turning angle thetaZ about the Y-axis of the device body 10 of the information processing device 1 is being kept within a range from −45° to +45° (the first state). Accordingly, the CPU 31 starts the barcode scanning of the barcode 111.

At this time, the CPU 31 controls the code scanner unit 13 to implement reading of the barcode 111 attached to the object 101.

FIG. 5 is a view showing a usage example, of RFID scanning of an RFID tag 121 attached to the object 101, using the information processing device of FIG. 1.

When an operator presses the button 12-1 in a state (the second state) in which the front face of the device body 10 of the information processing device 1 is inclined substantially in a vertical direction (the vertical direction in the X-Y plane), the information processing device 1 starts RFID scanning of the RFID tag 121.

That is, the start of scanning processing is instructed by the operator pressing the button 12-1 in a state in which the turning angle thetaZ about the Y-axis of the device body 10 of the information processing device 1 is being kept outside the range from −45° to +45° (the second state). Accordingly, the CPU 31 starts the RFID scanning of the RFID tag 121.

At this time, the CPU 31 controls the RFID reader/writer unit 14 to implement reading of the RFID tag 121 attached to the object 101.

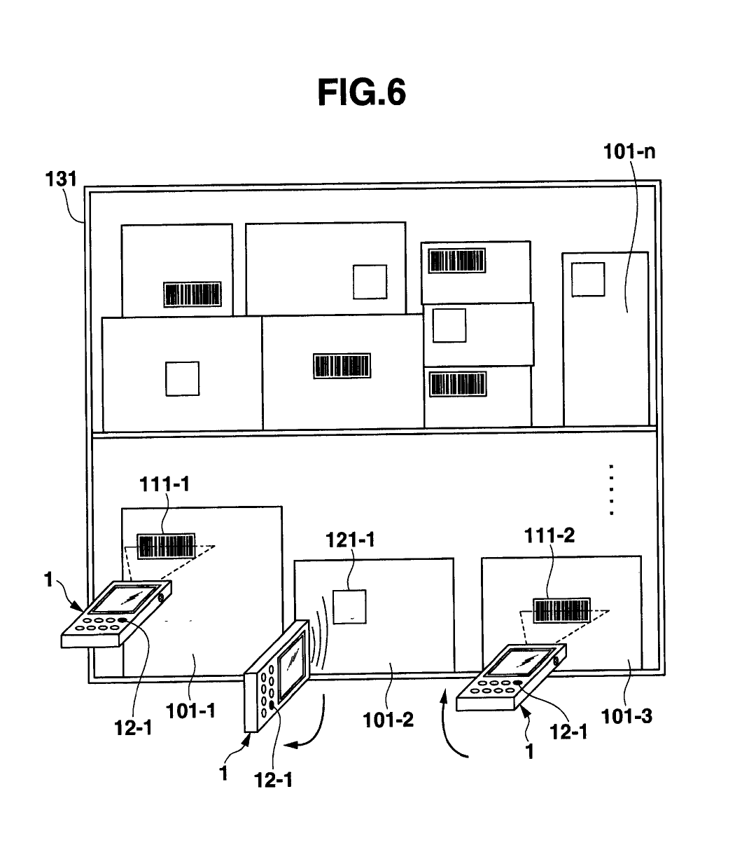

FIG. 6 is a view showing a usage example, of barcode scanning and RFID scanning of barcodes and RFID tags attached to n (n being an integer) objects 101-1, 101-2, 101-3, . . . 101-n plurally placed in a cabinet 131, using the information processing device 1 of FIG. 1.

As shown in FIG. 6, when a barcode 111-1 that has been adhered to the object 101-1 is to be read (scanned), the operator may perform barcode scanning of the barcode 111 by pressing the button 12-1 in the state (the first state) in which the front face of the device body 10 of the information processing device 1 is inclined substantially in the horizontal direction (the horizontal direction in the X-Y plane).

When an RFID tag 121-1 that has been adhered to the object 101-2 is to be read (scanned), the information processing device 1 may perform RFID scanning of the RFID tag 121 when the operator presses the button 12-1 in the state (the second state) in which the front face of the device body 10 of the information processing device 1 is inclined substantially in the vertical direction (the vertical direction in the X-Y plane).

Thus, the operator may successively read (scan) identifiers of plural types with different reading systems (the barcodes 111 and RFID tags 121 or the like) simply by inclining the device body 10 substantially to the horizontal direction in the X-Y plane or inclining the device body 10 substantially to the vertical direction.

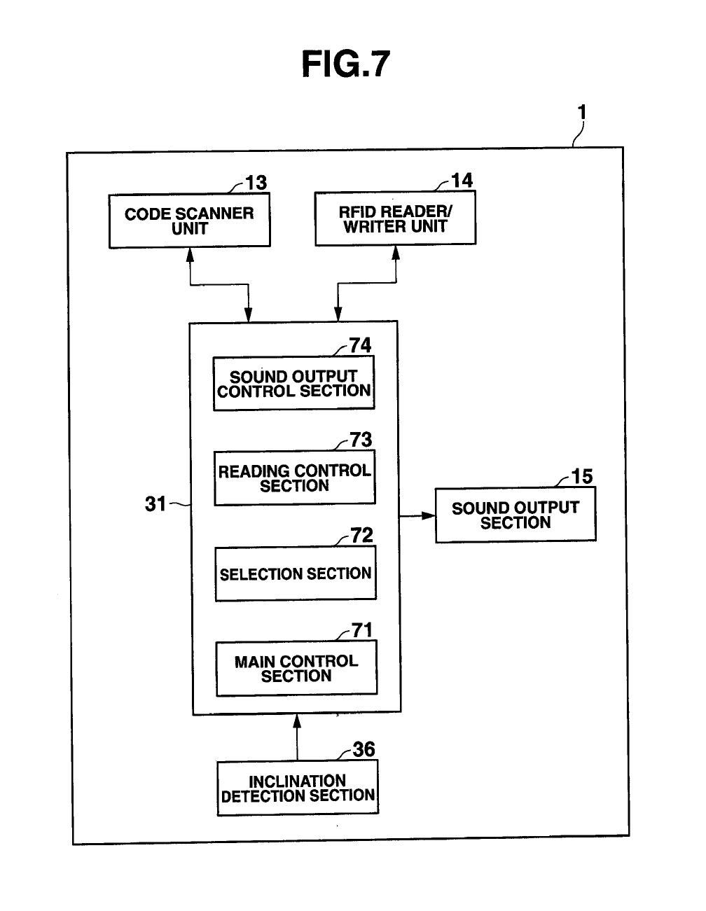

Next, functional structures of this information processing device 1 are described with reference to FIG. 7.

FIG. 7 is a functional block diagram showing, of functional structures of the information processing device 1, functional structures for executing scanning processing.

The meaning of the term “scanning processing” as used herein includes processing as follows, which is initiated by a power supply button, which is not shown in the drawings, being pressed by an operator. When the information processing device 1 detects an inclination with the inclination detection section 36 and the button 12-1 is pressed, the information processing device 1 executes reading processing on the basis of information on the detected inclination.

The information processing device 1 then emits a predetermined noise depending on whether or not the reading is successful. This sequence of processing is scanning processing.

The meaning of the term “reading processing” as used herein includes a sequence of processing, being processing in the scanning processing, in which the information processing device 1 carries out either barcode scanning or RFID scanning depending on the inclination information detected by the inclination detection section 36.

When the CPU 31 is controlling the execution of the scanning processing, the CPU 31 functions as a main control section 71, a selection section 72 and a reading control section 73.

When the scanning processing is being executed, the main control section 71 controls overall operations of the information processing device 1.

The selection section 72 acquires angular velocity values outputted from the inclination detection section 36. Then, in accordance with the acquired angular velocity values, which is to say the inclination of the device body 10, the selection section 72 selects a reading unit to read a reading target from among the reading units, which are the code scanner unit 13 and the RFID reader/writer unit 14 or the like.

That is, in accordance with the inclination state of the device body 10 specified by the inclination of the device body 10 detected by the inclination detection section 36, the selection section 72 selects one reading unit from a plural number of reading units that are provided to be capable of reading each of a plurality of types of identifier that differ in reading systems. In the present embodiment, the code scanner unit 13 and the RFID reader/writer unit 14 are employed as the reading units that read the plural identifiers with different reading systems. Therefore, the code scanner unit 13 or the RFID reader/writer unit 14 is selected.

Specifically in the present embodiment, the state in which the device body 10 is being kept with the turning angle thetaZ of the device body 10 about the Y-axis within the range from −45° to +45° is specified as being the first state. For example, a state in which the front face of the device body 10 is disposed substantially in the horizontal direction (the horizontal direction in the X-Y plane) corresponds to the first state.

On the other hand, the state in which the turning angle thetaZ of the device body 10 about the Y-axis is outside the range from −45° to +45° is specified as being the second state. For example, a state in which the front face of the device body 10 is disposed substantially in the vertical direction (the Z-axis direction) corresponds to the second state.

If the button 12-1 is pressed and the start of scanning processing is instructed when the device body 10 is in the first state, the selection section 72 selects the code scanner system and passes this selection result to the reading control section 73 and a sound output control section 74.

In contrast, if the button 12-1 is pressed and the start of scanning processing is instructed when the device body 10 is in the second state, the selection section 72 selects the RFID reader/writer unit 14 and passes this selection result to the reading control section 73 and the sound output control section 74.

The reading control section 73 executes control for reading an identifier with the reading unit selected by the selection section 72.

If the code scanner unit 13 has been selected by the selection section 72, the reading control section 73 controls the code scanner unit 13 to execute barcode scanning of a barcode 111.

On the other hand, if the RFID reader/writer unit 14 has been selected by the selection section 72, the reading control section 73 controls the RFID reader/writer unit 14 to execute RFID scanning of an RFID tag 121.

The reading control section 73 stores information read from the barcode 111 or RFID tag 121 in the storage section 37 or removable medium 61 or the like, and the main control section 71 processes the information read from the barcode 111 or RFID tag 121.

If the reading unit selection is changed by the selection section 72, the sound output control section 74 causes a predetermined sound to be outputted from the sound output section 15 to notify the operator of the change of reading unit.

Specifically, the sound output control section 74 outputs a first buzzer sound when the code scanner unit 13 is selected by the selection section 72. The first buzzer sound is a sound that is different from other buzzer sounds, such as a second buzzer sound which is described below. It is sufficient for the first buzzer sound to be a sound from which an operator may recognize that reading of a barcode 111 by the code scanner unit 13 is to be carried out.

The sound output control section 74 outputs the second buzzer sound when the RFID reader/writer unit 14 is selected by the selection section 72. The second buzzer sound is a sound from which an operator may recognize that reading of an RFID tag 121 by the RFID reader/writer unit 14 is to be carried out.

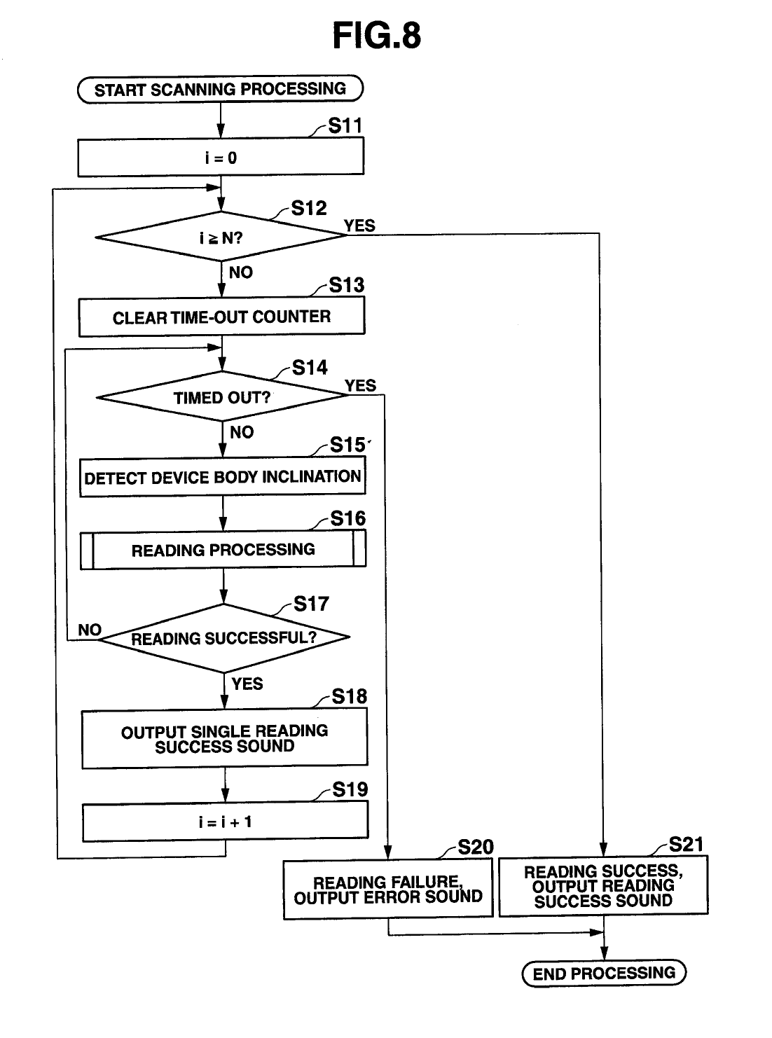

Next, the scanning processing that is executed by the information processing device 1 with the functional structure in FIG. 7 is described with reference to FIG. 8.

FIG. 8 is a flowchart describing a flow of the scanning processing that is executed by the information processing device 1 of FIG. 1 with the functional structures according to FIG. 7.

When the scanning processing is executed by the information processing device 1, the CPU 31 functions as the functional blocks in FIG. 7 and carries out the following processing. That is, in hardware, the CPU 31 corresponds to an agent of the processing in the following steps. However, for ease of understanding of the present invention, the processing of the steps that follow is described with the functional blocks implemented by the CPU 31 being treated as agents.

The start of the scanning processing is initiated by a power supply button (not shown in the drawings) of the information processing device 1 being pressed by an operator, and the following processing is repeatedly executed.

In step S11, the main control section 71 initializes a variable i.

In step S12, the main control section 71 makes a determination as to whether the variable i is at least a pre-specified number N of cycles of reading (scanning). This reading count N is a number of times reading is to be carried out by the code scanner unit 13 or RFID reader/writer unit 14.

If the variable i is equal to or greater than the specified reading count N, that is, if reading (scanning) the pre-specified number of times has been completed, the result of the determination in step S12 is affirmative and the processing advances to step S21.

If the variable i is less than the specified reading count N, that is, if reading the pre-specified number of times has not been completed, the result of the determination in step S12 is negative and the processing advances to step S13.

In step S13, the main control section 71 clears a time-out counter specified for timing out, and starts a count for timing out.

In step S14, the main control section 71 makes a determination as to whether the value of the time-out counter exceeds the threshold specified for timing out, and thus has timed out. The threshold for timing out may be set to an arbitrary duration. If the value of the time-out counter exceeds the threshold specified for timing out and has timed out, the result of the determination in step S14 is affirmative and the processing advances to step S20.

In step S20, the sound output control section 74 outputs an error sound indicating a reading failure. The error sound is a sound from which the operator may recognize that the reading (scanning) by the code scanner unit 13 or RFID reader/writer unit 14 has not been conducted in a certain duration and has timed out. The error sound may include, for example, a “boop” sound.

When the operator hears this error sound, the operator may understand that reading by the code scanner unit 13 or RFID reader/writer unit 14 has failed and ended due to timing out. When this processing is completed, the scanning processing ends.

On the other hand, if the value of the time-out counter is less than or equal to the threshold specified for timing out, that is, if the reading has not timed out, the result of the determination in step S14 is negative and the processing advances to step S15.

In step S15, the inclination detection section 36 detects an inclination of the device body 10 about the Y-axis. The detection of the inclination is implemented by detecting angular velocity values about the Y-axis.

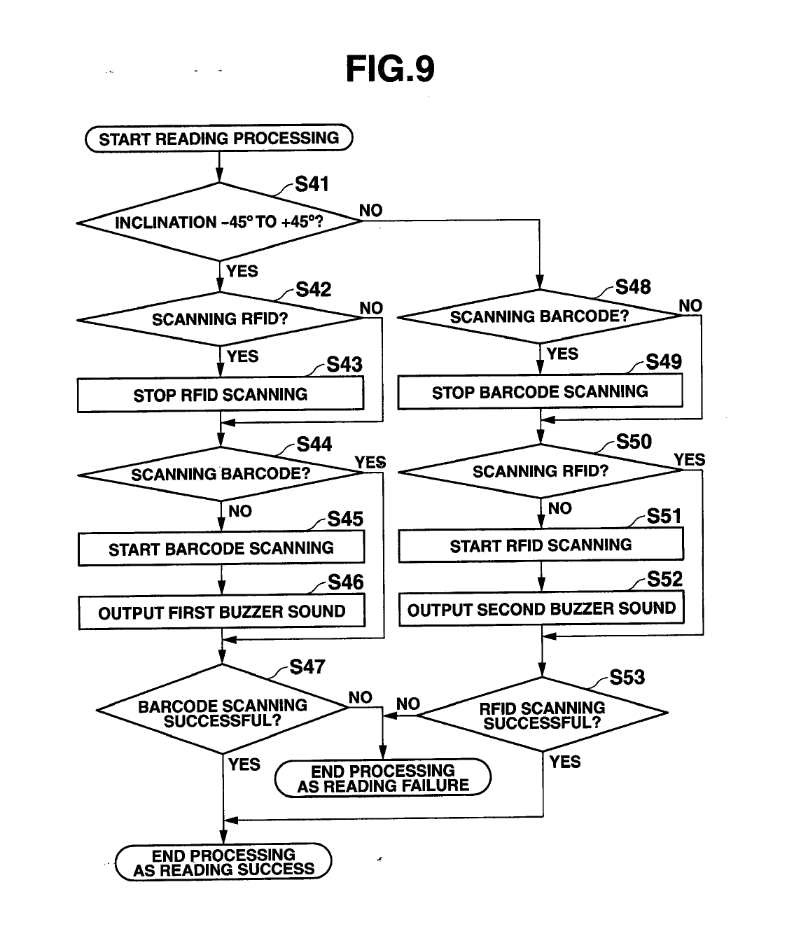

In step S16, the CPU 31 executes reading processing, which is described below with reference to FIG. 9. In the reading processing, in accordance with the angular velocity values detected by the inclination detection section 36, processing is carried out to select whether to start barcode scanning with the code scanner unit 13 or to start RFID scanning with the RFID reader/writer unit 14.

In step S17, the reading control section 73 makes a determination as to whether reading by the code scanner unit 13 or the RFID reader/writer unit 14 has succeeded. If reading by the code scanner unit 13 or RFID reader/writer unit 14 has not succeeded, the result of the determination in step S17 is negative and the processing returns to step S14.

In other words, the processing in steps S14 to S17 is repeated until reading by the code scanner unit 13 or RFID reader/writer unit 14 is successful. On the other hand, if the reading by the code scanner unit 13 or RFID reader/writer unit 14 has succeeded, the result of the determination in step S17 is affirmative and the processing advances to step S18.

In step S18, the sound output control section 74 outputs a single reading success sound. In this processing, the sound output control section 74 outputs a reading success sound to notify the operator that reading has succeeded each time reading by the code scanner unit 13 or the RFID reader/writer unit 14 is successful.

The reading success sound is a sound from which an operator may recognize that reading of a barcode 111 or RFID tag 121 by the code scanner unit 13 or RFID reader/writer unit 14 has been conducted. The reading success sound includes for example, a “beep” sound. When the operator hears this reading success sound, the operator may understand that one reading has succeeded.

The reading success sound may be a different sound for different reading systems. Specifically, when a reading of a barcode 111 by the code scanner unit 13 succeeds, the sound output control section 74 outputs a first reading success sound which is a “beep-beep” sound, and when a reading of an RFID tag 121 by the RFID reader/writer unit 14 succeeds, the sound output control section 74 outputs a second reading success sound which is a “boop-boop” sound.

When the operator hears the different types of reading success sound, the operator may understand which types of identifiers are being read.

In step S19, the main control section 71 adds 1 to the variable i. When this processing is complete, the processing returns to step S12. In other words, the variable i is incremented each time reading by the code scanner unit 13 or RFID reader/writer unit 14 is successful, and the reading processing in step S16 is carried out until readings by the code scanner unit 13 or RFID reader/writer unit 14 reach the pre-specified reading count N. When the readings by the code scanner unit 13 or RFID reader/writer unit 14 reach the specified reading count N, the result of the determination in step S12 is affirmative and the processing advances to step S21.

In step S21, the sound output control section 74 outputs a reading success sound indicating successful reading. This reading success sound is a sound from which an operator may recognize that readings by the code scanner unit 13 or RFID reader/writer unit 14 have reached the pre-specified reading count N. This reading success sound includes, for example, a “bing-bong” sound.

When the operator hears this reading success sound, the operator may understand that readings by the code scanner unit 13 or RFID reader/writer unit 14 have succeeded up to the specified number of reading cycles N. When this processing is completed, the scanning processing ends.

Next, the reading processing in step S16 of this scanning processing is described in detail.

FIG. 9 is a flowchart describing details of the reading processing in the scanning processing according to FIG. 8.

As described above, the reading processing is started as the processing of step S16, initiated by the inclination of the device body 10 about the Y-axis being detected by the inclination detection section 36.

In step S41, the selection section 72 makes a determination as to whether the inclination detected by the inclination detection section 36, that is, the turning angle thetaZ about the Y-axis, is in the range from −45° to +45°. If the inclination is in the range from −45° to +45°, the result of the determination in step S41 is affirmative and the processing advances to step S42. When the inclination is in the range from −45° to +45°, the selection section 72 selects the code scanning system that reads barcodes with the code scanner unit 13, and the following processing from step S42 to step S46 is carried out.

In step S42, the reading control section 73 makes a determination as to whether an RFID is presently being scanned. If no RFID is presently being scanned, the result of the determination in step S42 is negative and the processing advances to step S44. On the other hand, if an RFID is presently being scanned, the result of the determination in step S42 is affirmative and the processing advances to step S43.

In step S43, the reading control section 73 controls the RFID reader/writer unit 14 to stop the RFID scan.

In step S44, the reading control section 73 makes a determination as to whether a barcode is presently being scanned. If a barcode is presently being scanned, the result of the determination in step S44 is affirmative and the processing advances to step S47. On the other hand, if no barcode is presently being scanned, the result of the determination in step S44 is negative and the processing advances to step S45.

In step S45, the selection section 72 selects the code scanner unit 13 and sets barcode scanning as the reading system. Then the reading control section 73 controls the code scanner unit 13 to start barcode scanning.

In step S46, the sound output control section 74 outputs a first buzzer sound. In this processing, the first buzzer sound is outputted when the reading system is changed from the RFID scanning system that reads RFID tags with the RFID reader/writer unit 14 to the code scanning system that reads barcodes with the code scanner unit 13. That is, the first buzzer sound is outputted when a different reading unit from previously is selected.

The first buzzer sound is a sound from which an operator may recognize that a different reading unit from before has been selected. When the operator hears the first buzzer sound, the operator may understand that the information processing device 1 has changed from the RFID scanning system in which the RFID reader/writer unit 14 is selected and RFID tags are read to the code scanning system in which the code scanner unit 13 is selected and barcodes are read.

In step S47, the reading control section 73 makes a determination as to whether a barcode scan has succeeded. If the barcode scan has succeeded, the result of the determination in step S47 is affirmative, and the reading processing ends with the reading as a success. On the other hand, if the barcode scan has failed, the result of the determination in step S47 is negative, and the reading processing ends with the reading as a failure.

Alternatively, if the inclination detected by the inclination detection section 36 is outside the range from −45° to +45°, the result of the determination in step S41 is negative and the processing advances to step S48. When the inclination is outside the range from −45° to +45°, the selection section 72 selects the RFID scanning system that reads RFID tags with the RFID reader/writer unit 14, and the following processing from step S48 to step S52 is carried out.

In step S48, the reading control section 73 makes a determination as to whether a barcode is presently being scanned. If no barcode is presently being scanned, the result of the determination in step S48 is negative and the processing advances to step S50. On the other hand, if a barcode is presently being scanned, the result of the determination in step S48 is affirmative and the processing advances to step S49.

In step S49, the reading control section 73 controls the code scanner unit 13 to stop the barcode scan.

In step S50, the reading control section 73 makes a determination as to whether an RFID is presently being scanned. If an RFID is presently being scanned, the result of the determination in step S50 is affirmative and the processing advances to step S53. On the other hand, if no RFID is presently being scanned, the result of the determination in step S50 is negative and the processing advances to step S51.

In step S51, the selection section 72 selects the RFID reader/writer unit 14 and sets RFID scanning as the reading system. Then the reading control section 73 controls the RFID reader/writer unit 14 to start RFID scanning with the RFID reader/writer unit 14.

In step S52, the sound output control section 74 outputs a second buzzer sound. In this processing, the second buzzer sound is outputted when the reading system is changed from the code scanning system that reads barcodes with the code scanner unit 13 to the RFID scanning system that reads RFID tags with the RFID reader/writer unit 14. That is, the second buzzer sound is outputted when a different reading unit from previously is selected.

The second buzzer sound is a sound from which an operator may recognize that a different reading unit from before has been selected. When the operator hears the second buzzer sound, the operator may understand that the information processing device 1 has changed from the code scanning system in which the code scanner unit 13 is selected and barcodes are read to the RFID scanning system in which the RFID reader/writer unit 14 is selected and RFID tags are read.

In step S53, the reading control section 73 makes a determination as to whether an RFID scan has succeeded. If the RFID scan has succeeded, the result of the determination in step S53 is affirmative, and the reading processing ends with the reading as a success. On the other hand, if the RFID scan has failed, the result of the determination in step S53 is negative, and the reading processing ends with the reading as a failure.

As is described hereabove, the information processing device 1 according to the first embodiment is equipped with the device body 10, the code scanner unit 13, the RFID reader/writer unit 14, the inclination detection section 36, the selection section 72 and the reading control section 73.

The code scanner unit 13 and RFID reader/writer unit 14 that read identifiers of a plural number of different reading systems are provided at the device body 10 and read, respectively, barcodes and RFID tags. The inclination detection section 36 detects an inclination of the device body 10.

In accordance with the inclination of the device body 10 detected by the inclination detection section 36, the selection section 72 selects any one reading unit from the code scanner unit 13 and the RFID reader/writer unit 14. Then, for a barcode or RFID tag, depending on the reading unit selected by the selection section 72, the reading control section 73 implements control of the reading by the code scanner unit 13 or RFID reader/writer unit 14 of the identifier that corresponds to that reading unit.

Thus, an operator may select a reading unit in accordance with an identifier just by inclining the device body 10 in accordance with the type of the identifier. Therefore, the operator may easily perform reading of identifiers regardless of the types of identifiers simply by looking at an identifier attached to an object and tilting their wrist to an angle corresponding to the identifier attached to that object. Thus, reading operations may be carried out without the operator having to check a separate switching control when selecting a reading unit, and the efficiency of operator operations may be improved.

Moreover, the information processing device 1 is equipped with the plural reading units (the code scanner unit 13 and RFID reader/writer unit 14) respectively corresponding to the plural identifiers of different reading systems (barcodes and RFID tags). The reading control section 73 executes control of reading, by a reading unit selected by the selection section 72 from the code scanner unit 13 and the RFID reader/writer unit 14, of identifiers corresponding to that reading unit.

Thus, an operator may control the reading unit that is most suitable for a type of identifier (the code scanner unit 13 or the RFID reader/writer unit 14) and read the identifier, which is a barcode or an RFID tag, just by tilting the device body 10 in accordance with the type of identifier.

The information processing device 1 is also equipped with the sound output control section 74 that executes control to output a sound when a reading unit different from previously is selected by the selection section 72. Thus, an operator may be notified that the reading unit has been switched to a different reading unit from before. Therefore, the operator may recognize that the reading unit has been changed just by identifying the sound, without having to check a control section or display section of the information processing device 1 or the like.

Hereabove, the information processing device 1 is described in accordance with the first embodiment of the present invention.

Next, the information processing device 1 is described in accordance with a second embodiment of the present invention.

### Second Embodiment

The information processing device 1 according to the second embodiment of the present invention may assume basically the same hardware structure and functional structure as the information processing device 1 according to the first embodiment.

Therefore, FIG. 3 is also usable as a block diagram showing hardware structures of the image processing device 1 in accordance with the second embodiment.

However, the present embodiment differs in that while the first embodiment reads barcode and RFID tag identifiers with the code scanner unit 13 and the RFID reader/writer unit 14, the second embodiment only reads RFID tags with the RFID reader/writer unit 14.

The RFID reader/writer unit 14 of the second embodiment performs single readings and batch readings of the information of RFID tags via the antenna 51. Here below, individual reading of a single RFID tag with the RFID reader/writer unit 14 is referred to as “RFID single scanning”.

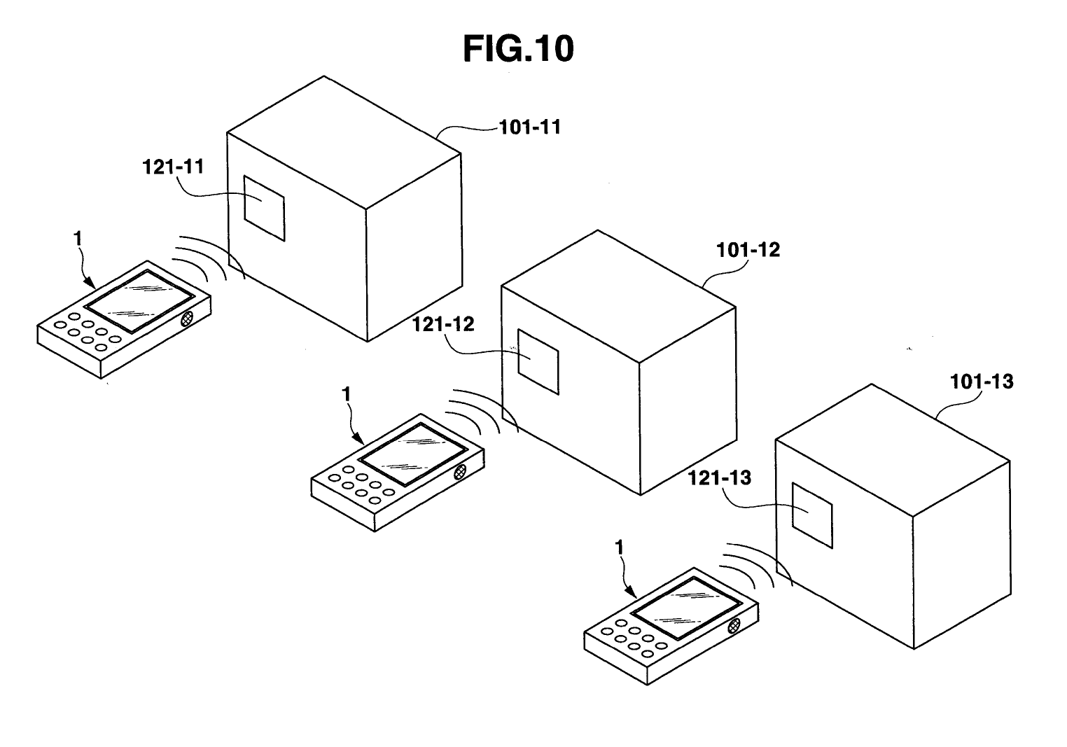

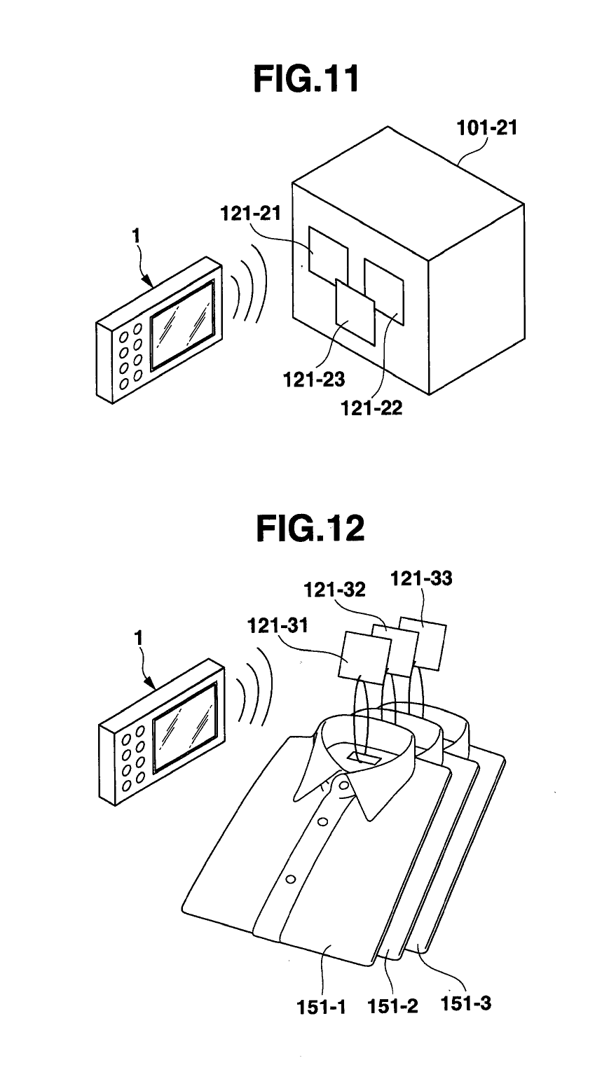

Details of RFID single scanning are described below with reference to FIG. 10. In contrast, reading of plural RFID tags in a batch at the same time with the RFID reader/writer unit 14 is referred to as “RFID batch scanning”. Details of RFID batch scanning are described below with reference to FIG. 11 and FIG. 12.

FIG. 10 is a view showing a usage example, of RFID single scanning of RFID tags 121-11, 121-12 and 121-13 respectively attached to objects 101-11, 101-12 and 101-13, using the information processing device 1 of the second embodiment;

RFID single scanning is performed when a single RFID tag is attached to a single object and RFID tags should be read (scanned) one at a time.

When an operator presses the button 12-1 in the state (the first state) in which the front face of the device body 10 of the information processing device 1 is inclined substantially in the horizontal direction (the horizontal direction in the X-Y plane), the information processing device 1 starts RFID single scanning of the RFID tags 121-11, 121-12 and 121-13.

That is, the start of scanning processing is instructed by the operator pressing the button 12-1 in a state in which the turning angle thetaZ about the Y-axis of the device body 10 of the information processing device 1 is being kept within the range from −45° to +45° (the first state). Accordingly, the CPU 31 starts RFID single scanning of the RFID tags 121-11, 121-12 and 121-13. In this case, the CPU 31 controls the code scanner unit 13 to implement respectively separate reading of the RFID tags 121-11, 121-12 and 121-13 that are attached, respectively, to the objects 101-11, 101-12 and 101-13.

FIG. 11 is a view showing a usage example, of RFID batch scanning of plural RFID tags 121-21, 121-22 and 121-23 attached to a single object 101-21, using the information processing device 1 of FIG. 1.

In the present embodiment, an example is described in which three RFID tags are attached to a single object. RFID batch scanning is performed when a plural number of RFID tags are attached to a single object and the plural RFID tags should be read (scanned) as a set.

As illustrated in FIG. 11, if RFID single scanning is performed in a case in which the RFID tags 121-21, 121-22 and 121-23 are close to one another, the same RFID tag 121-21, 121-22 or 121-23 may be read (scanned) repeatedly. However, when RFID batch scanning is performed, duplicate reading of the RFID tags 121-21, 121-22 and 121-23 may be avoided.

When an operator presses the button 12-1 in the state (the second state) in which the front face of the device body 10 of the information processing device 1 is inclined substantially in the vertical direction (the vertical direction in the X-Y plane), the information processing device 1 starts RFID batch scanning of the RFID tags 121-21, 121-22 and 121-23.

That is, the start of scanning processing is instructed by the operator pressing the button 12-1 in a state in which the turning angle thetaZ about the Y-axis of the device body 10 of the information processing device 1 is being kept outside the range from −45° to +45° (the second state). Accordingly, the CPU 31 starts the RFID batch scanning of the RFID tags 121-21, 121-22 and 121-23.

In this case, the CPU 31 controls the RFID reader/writer unit 14 to read (scan) the RFID tags 121-21, 121-22 and 121-23 attached to the object 101-21 all together.

RFID batch scanning is carried out both when reading (scanning) plural RFID tags attached to a single object and when reading (scanning) RFID tags attached to plural objects that are disposed close to one another.

Next, an example of reading (scanning) of plural RFID tags that are attached to plural objects disposed close to one another is described with reference to FIG. 12.

FIG. 12 is a view showing a usage example, of RFID batch scanning of plural RFID tags 121-31, 121-32 and 121-33 attached to plural objects (clothing items) 151-1, 151-2 and 151-3, respectively, that are disposed close together, using the information processing device 1 of FIG. 1.

In the present embodiment, an example is described in which three RFID tags 121-31, 121-32 and 121-33 are attached to three objects 151-1, 151-2 and 151-3.

RFID batch scanning is performed when a plural number of RFID tags are attached to plural respective objects and the plural RFID tags should be read (scanned) as a single set.

When an operator presses the button 12-1 in the state (the second state) in which the front face of the device body 10 of the information processing device 1 is inclined substantially in the vertical direction (the vertical direction in the X-Y plane), the information processing device 1 starts RFID batch scanning of the RFID tags 121-31, 121-32 and 121-33.

That is, the start of scanning processing is instructed by the operator pressing the button 12-1 in a state in which the turning angle thetaZ about the Y-axis of the device body 10 of the information processing device 1 is being kept outside the range from −45° to +45° (the second state). Accordingly, the CPU 31 starts RFID batch scanning of the RFID tags 121-31, 121-32 and 121-33. In this case, the CPU 31 controls the RFID reader/writer unit 14 to read (scan) the RFID tags 121-31, 121-32 and 121-33 attached to the objects 151-1, 151-2 and 151-3 all together.

The scanning processing that is executed by the information processing device 1 according to the second embodiment basically has the same flow as the scanning processing according to the first embodiment. Therefore, FIG. 8 is also usable as a flowchart describing a flow of the scanning processing according to the second embodiment.

Moreover, the reading processing that is executed by the information processing device 1 according to the second embodiment basically has the same flow as the reading processing according to the first embodiment. Therefore, FIG. 9 is also usable as a flowchart describing a flow of the reading processing according to the second embodiment.

However, in the reading processing of the second embodiment, the system that is selected in accordance with the inclination detected by the inclination detection section 36 is one of RFID single scanning and RFID batch scanning.

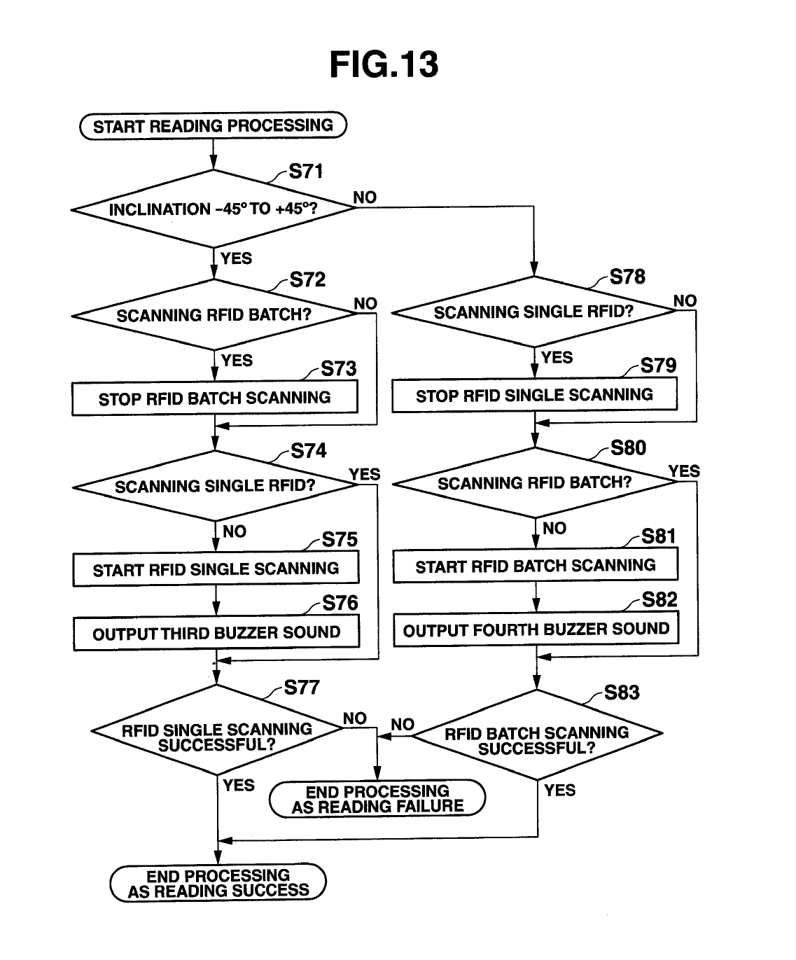

Therefore, for the reading processing of the second embodiment, the flowchart of FIG. 13 is employed instead of the flowchart of FIG. 9 that is employed in the first embodiment.

FIG. 13 is a flowchart describing a flow of reading processing in accordance with the second embodiment, which is executed by the information processing device 1 of FIG. 1 equipped with the functional structures of FIG. 7.

In the first embodiment of the reading processing in FIG. 9 described above, the system that is selected in accordance with the inclination detected by the inclination detection section 36 is either barcode scanning or RFID scanning. In contrast, the second embodiment of the reading processing differs in that the system that is selected in accordance with the inclination of the device body 10 is either RFID single scanning or RFID batch scanning. More specifically, the second embodiment differs in that the processing of steps S72 to S83 is executed instead of the processing of steps S42 to S53 according to the first embodiment.

Accordingly, the following descriptions mainly describe this difference, and descriptions of similarities are omitted as appropriate.

In step S71, the selection section 72 makes a determination as to whether an inclination detected by the inclination detection section 36, that is, the turning angle thetaZ about the Y-axis, is in the range from −45° to +45°. If the inclination is in the range from −45° to +45°, the result of the determination in step S71 is affirmative and the processing advances to step S72.

When the inclination is in the range from −45° to +45°, the selection section 72 selects the system for reading RFID tags singly with the RFID reader/writer unit 14, and the following processing from step S72 to step S76 is carried out.

In step S72, the reading control section 73 makes a determination as to whether a batch of RFIDs is presently being scanned. If no RFID batch is presently being scanned, the result of the determination in step S72 is negative and the processing advances to step S74. On the other hand, if an RFID batch is presently being scanned, the result of the determination in step S72 is affirmative and the processing advances to step S73.

In step S73, the reading control section 73 controls the RFID reader/writer unit 14 to stop the RFID batch scanning.

In step S74, the reading control section 73 makes a determination as to whether a single RFID is presently being scanned. If a single RFID is presently being scanned, the result of the determination in step S74 is affirmative and the processing advances to step S77. On the other hand, if no single RFID is presently being scanned, the result of the determination in step S74 is negative and the processing advances to step S75.

In step S75, the selection section 72 selects the RFID reader/writer unit 14 and sets RFID scanning as the reading system. Then the reading control section 73 controls the RFID reader/writer unit 14 to start RFID single scanning.

In step S76, the sound output control section 74 outputs a third buzzer sound. In this processing, the third buzzer sound is outputted when the reading system is changed from the reading system that reads RFID tags in batches with the RFID reader/writer unit 14 to the reading system that reads RFID tags singly with the RFID reader/writer unit 14. That is, the third buzzer sound is outputted when a different reading system from previously is selected.

The third buzzer sound is a sound from which an operator may recognize that a different reading system from before has been selected. When the operator hears the third buzzer sound, the operator may understand that the reading system has changed from the system that reads RFID tags in batches with the RFID reader/writer unit 14 to the system that reads single RFID tags with the RFID reader/writer unit 14.

In step S77, the reading control section 73 makes a determination as to whether an RFID single scan has succeeded. If the RFID single scan has succeeded, the result of the determination in step S77 is affirmative, and the reading processing ends with the reading as a success. On the other hand, if the RFID single scan has failed, the result of the determination in step S77 is negative, and the reading processing ends with the reading as a failure.

Alternatively, if the inclination detected by the inclination detection section 36 is outside the range from −45° to +45°, the result of the determination in step S71 is negative and the processing advances to step S78. When the inclination is outside the range from −45° to +45°, the selection section 72 selects the reading system that reads RFID tags in batches with the RFID reader/writer unit 14, and the following processing from step S78 to step S82 is carried out.

In step S78, the reading control section 73 makes a determination as to whether a single RFID is presently being scanned. If no single RFID is presently being scanned, the result of the determination in step S78 is negative and the processing advances to step S80. On the other hand, if a single RFID is presently being scanned, the result of the determination in step S78 is affirmative and the processing advances to step S79.

In step S79, the reading control section 73 controls the RFID reader/writer unit 14 to stop the RFID single scanning.

In step S80, the reading control section 73 makes a determination as to whether an RFID batch is presently being scanned. If an RFID batch is presently being scanned, the result of the determination in step S80 is affirmative and the processing advances to step S83. On the other hand, if no RFID batch is presently being scanned, the result of the determination in step S80 is negative and the processing advances to step S81.

In step S81, the selection section 72 sets RFID batch scanning as the reading system. Then the reading control section 73 controls the RFID reader/writer unit 14 to start RFID batch scanning.

In step S82, the sound output control section 74 outputs a fourth buzzer sound. In this processing, the fourth buzzer sound is outputted when the reading system is changed from the reading system that reads RFID tags singly with the RFID reader/writer unit 14 to the reading system that reads RFID tags in batches with the RFID reader/writer unit 14. That is, the fourth buzzer sound is outputted when a different reading system from previously is selected. The fourth buzzer sound is a sound from which an operator may recognize that a different reading system from before has been selected. When the operator hears the fourth buzzer sound, the operator may understand that the reading system has changed from the system that reads single RFID tags with the RFID reader/writer unit 14 to the system that reads RFID tags in batches with the RFID reader/writer unit 14.

In step S83, the reading control section 73 makes a determination as to whether an RFID batch scan has succeeded. If the RFID batch scan has succeeded, the result of the determination in step S83 is affirmative, and the reading processing ends with the reading as a success. On the other hand, if the RFID batch scan has failed, the result of the determination in step S83 is negative, and the reading processing ends with the reading as a failure.

As is described here above, the selection section 72 of the information processing device 1 according to the second embodiment selects, in accordance with an inclination of the device body 10 detected by the inclination detection section, one reading system from plural reading systems, including at least single scanning that singly reads plural RFID tags respectively separately, and RFID batch scanning that reads plural RFID tags all together. Then the reading control section 73 implements control of the reading of RFID tags in batches or singly with the reading system selected by the selection section 72.

An operator may select either of the single scanning system and the batch scanning system simply by inclining the device body in accordance with a type of identifiers. Therefore, the operator may easily perform reading of identifiers irrespective of the form of attached identifiers simply by looking at the identifiers attached to objects and tilting their wrist. Thus, reading operations may be carried out without the operator having to check a separate switching control when selecting a reading system, and the efficiency of operator operations may be improved.

Here above, the information processing device 1 is described in accordance with the second embodiment of the present invention.

Next, the information processing device 1 is described in accordance with a third embodiment of the present invention.

### Third Embodiment

The information processing device 1 according to the third embodiment of the present invention may assume basically the same hardware structure and functional structure as the information processing device 1 according to the first embodiment.

Therefore, FIG. 3 is also usable as a block diagram showing hardware structures of the image processing device 1 in accordance with the third embodiment.

However, while barcode and RFID tag identifiers are read by the code scanner unit 13 and the RFID reader/writer unit 14 in the first embodiment, the third embodiment differs in that two-dimensional codes are read by the code scanner unit 13 as well.

Thus, the code scanner unit 13 of the third embodiment reads two-dimensional codes in addition to reading barcodes. Here below, reading of two-dimensional codes by the code scanner unit 13 is referred to as “two-dimensional code scanning”. A two-dimensional code is constituted by an identifier in which information is recorded in a two-dimensional graphic pattern. In the present embodiment, a variety of two-dimensional codes may be employed regardless of type, such as QR Codes (registered trademark), CP Codes, Data Matrix codes and the like.

The scanning processing that is executed by the information processing device 1 according to the third embodiment basically has the same flow as the scanning processing according to the first embodiment. Therefore, FIG. 8 is also usable as a flowchart describing a flow of the scanning processing according to the third embodiment.

Moreover, the reading processing that is executed by the information processing device 1 according to the third embodiment basically has the same flow as the reading processing according to the first embodiment. Therefore, FIG. 9 is also usable as a flowchart describing a flow of the reading processing according to the third embodiment.

However, while barcode and RFID tag identifiers are read by the code scanner unit 13 and the RFID reader/writer unit 14 in the first embodiment, the third embodiment differs in that two-dimensional codes are read by the code scanner unit 13 as well.

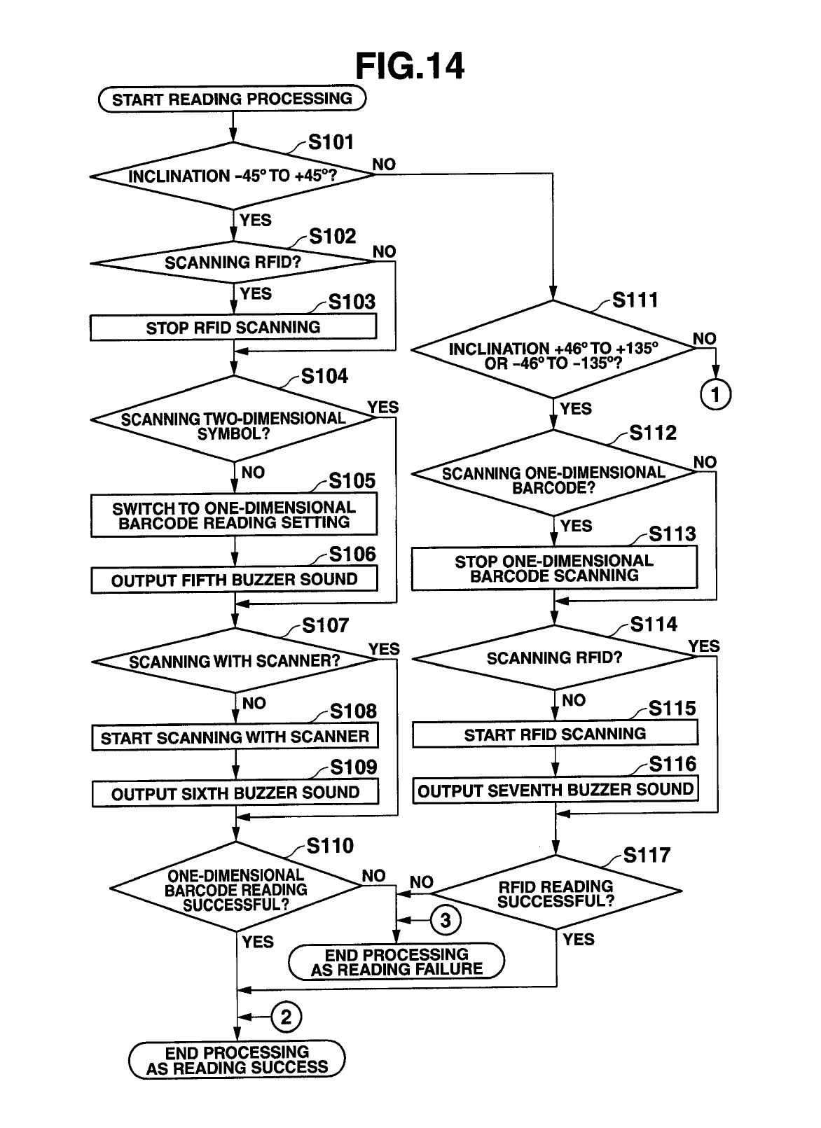

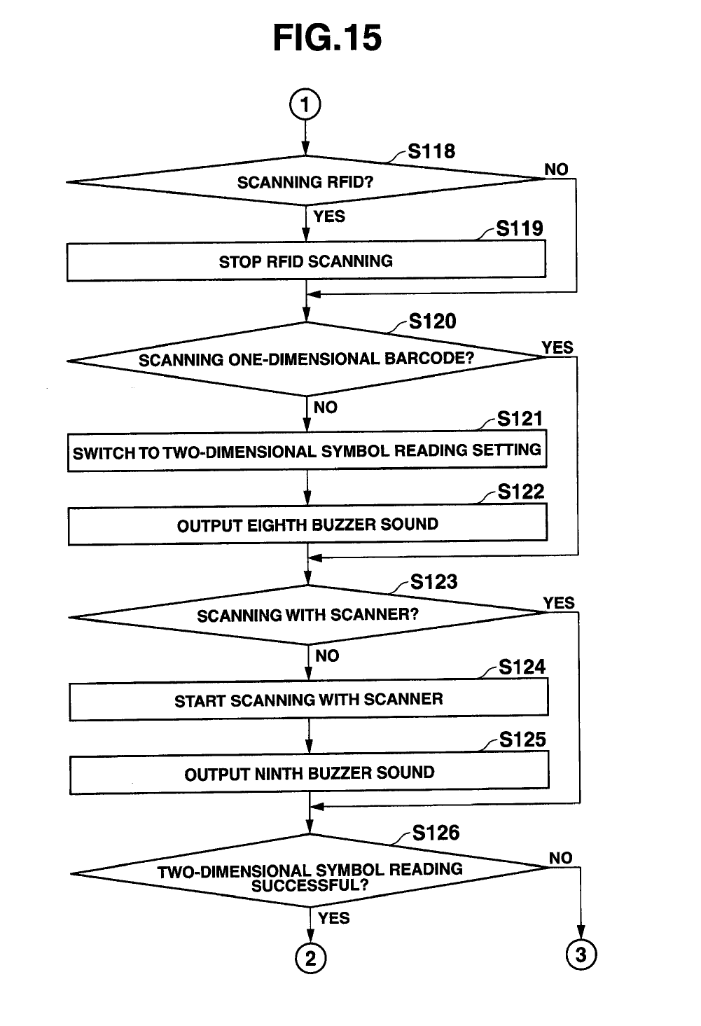

Therefore, for the reading processing of the third embodiment, the flowchart of FIG. 14 and FIG. 15 is employed instead of the flowchart of FIG. 9 that is employed in the first embodiment.

FIG. 14 and FIG. 15 are a flowchart describing the flow of reading processing in accordance with the third embodiment, which is executed by the information processing device 1 of FIG. 3 equipped with the functional structures of FIG. 7.

In the first embodiment of the reading processing in FIG. 9 described above, barcode scanning or RFID scanning starts in accordance with the inclination detected by the inclination detection section 36. In contrast, the third embodiment of the reading processing differs in that barcode scanning, two-dimensional code scanning or RFID scanning starts in accordance with the detected inclination.

Accordingly, the following descriptions mainly describe this difference, and descriptions of similarities are omitted as appropriate.

In step S101, the selection section 72 makes a determination as to whether an inclination detected by the inclination detection section 36, that is, the turning angle thetaZ about the Y-axis, is in the range from −45° to +45°. If the inclination is in the range from −45° to +45°, the result of the determination in step S101 is affirmative and the processing advances to step S102. When the inclination is in the range from −45° to +45°, the selection section 72 selects the system for reading barcodes with the code scanner unit 13, and the following processing from step S102 to step S109 is carried out.

In step S102, the reading control section 73 makes a determination as to whether an RFID is presently being scanned. If no RFID is presently being scanned, the result of the determination in step S102 is negative and the processing advances to step S104. On the other hand, if an RFID is presently being scanned, the result of the determination in step S102 is affirmative and the processing advances to step S103.

In step S103, the reading control section 73 controls the RFID reader/writer unit 14 to stop the RFID scanning.

In step S104, the reading control section 73 makes a determination as to whether a two-dimensional code is presently being scanned. If a two-dimensional code is presently being scanned, the result of the determination in step S104 is affirmative and the processing advances to step S107. On the other hand, if no two-dimensional code is presently being scanned, the result of the determination in step S104 is negative and the processing advances to step S105.

In step S105, the selection section 72 sets barcode scanning as the reading system. Then the reading control section 73 controls the code scanner unit 13 to start barcode scanning.

In step S106, the sound output control section 74 outputs a fifth buzzer sound. In this processing, the fifth buzzer sound is outputted when the reading system is changed from the system that reads two-dimensional codes with the code scanner unit 13 to the system that reads barcodes. That is, the fifth buzzer sound is outputted when a different reading system from previously is selected.

The fifth buzzer sound is a sound from which an operator may recognize that a different reading system from before has been selected. When the operator hears the fifth buzzer sound, the operator may understand that the reading system has changed from the system that reads two-dimensional codes with the code scanner unit 13 to the system that reads barcodes.

In step S107, the reading control section 73 makes a determination as to whether a barcode is presently being scanned. If a barcode is presently being scanned, the result of the determination in step S107 is affirmative and the processing advances to step S110. On the other hand, if no barcode is presently being scanned, the result of the determination in step S107 is negative and the processing advances to step S108.

In step S108, the selection section 72 sets barcode scanning as the reading system. Then the reading control section 73 controls the code scanner unit 13 to start barcode scanning.

In step S109, the sound output control section 74 outputs a sixth buzzer sound. In this processing, the sixth buzzer sound is outputted when the reading system is changed from the system that reads RFID tags with the RFID reader/writer unit 14 to the system that reads barcodes with the code scanner unit 13. That is, the sixth buzzer sound is outputted when a different reading system from previously is selected.

The sixth buzzer sound is a sound from which an operator may recognize that a different reading system from before has been selected. When the operator hears the sixth buzzer sound, the operator may understand that the reading system has changed from the system that reads RFID tags with the RFID reader/writer unit 14 to the system that reads barcodes with the code scanner unit 13. The sixth buzzer sound may be a sound with the same composition as the fifth buzzer sound.

In step S110, the reading control section 73 makes a determination as to whether a barcode scan has succeeded. If the barcode scan has succeeded, the result of the determination in step S110 is affirmative, and the reading processing ends with the reading as a success.

On the other hand, if the barcode scan has failed, the result of the determination in step S110 is negative, and the reading processing ends with the reading as a failure.

Alternatively, if the inclination detected by the inclination detection section 36 is outside the range from −45° to +45°, the result of the determination in step S101 is negative and the processing advances to step S111.

In step S111, the selection section 72 makes a determination as to whether the inclination detected by the inclination detection section 36, that is, the turning angle thetaZ about the Y-axis, is in a range from +46° to +135° and from −46° to −135°.

If the inclination is in the range from +46° to +135° and −46° to −135°, the result of the determination in step S111 is affirmative and the processing advances to step S112.

When the inclination is in the range from +46° to +135° and −46° to −135°, the selection section 72 selects the system for reading RFID tags with the RFID reader/writer unit 14, and the following processing from step S112 to step S116 is carried out.

In step S112, the reading control section 73 makes a determination as to whether a barcode is presently being scanned. If no barcode is presently being scanned, the result of the determination in step S112 is negative and the processing advances to step S114. On the other hand, if a barcode is presently being scanned, the result of the determination in step S112 is affirmative and the processing advances to step S113.

In step S113, the reading control section 73 controls the code scanner unit 13 to stop the barcode scanning.

In step S114, the reading control section 73 makes a determination as to whether an RFID is presently being scanned. If an RFID is presently being scanned, the result of the determination in step S114 is affirmative and the processing advances to step S117. On the other hand, if no RFID is presently being scanned, the result of the determination in step S114 is negative and the processing advances to step S115.

In step S115, the selection section 72 sets RFID scanning as the reading system. Then the reading control section 73 controls the RFID reader/writer unit 14 to start RFID scanning with the RFID reader/writer unit 14.

In step S116, the sound output control section 74 outputs a seventh buzzer sound. In this processing, the seventh buzzer sound is outputted when the reading system is changed from the system that reads barcodes with the code scanner unit 13 to the system that reads RFID tags with the RFID reader/writer unit 14. That is, the seventh buzzer sound is outputted when a different reading system from previously is selected.

The seventh buzzer sound is a sound from which an operator may recognize that a different reading system from before has been selected. When the operator hears the seventh buzzer sound, the operator may understand that the reading system has changed from the system that reads barcodes with the code scanner unit 13 to the system that reads RFID tags with the RFID reader/writer unit 14.

In step S117, the reading control section 73 makes a determination as to whether an RFID scan has succeeded. If the RFID scan has succeeded, the result of the determination in step S117 is affirmative, and the reading processing ends with the reading as a success. On the other hand, if the RFID scan has failed, the result of the determination in step S117 is negative, and the reading processing ends with the reading as a failure.

Alternatively at step S111, if the inclination detected by the inclination detection section 36 is outside the range from +46° to +135° and −46° to −135°, the result of the determination in step S111 is negative and the processing advances to step S118. When the inclination is outside the range from +46° to +135° and −46° to −135°, the selection section 72 selects the system for reading two-dimensional codes with the code scanner unit 13, and the following processing from step S118 to step S125 is carried out.

In step S118, the reading control section 73 makes a determination as to whether an RFID is presently being scanned. If no RFID is presently being scanned, the result of the determination in step S118 is negative and the processing advances to step S120. On the other hand, if an RFID is presently being scanned, the result of the determination in step S118 is affirmative and the processing advances to step S119.

In step S119, the reading control section 73 controls the RFID reader/writer unit 14 to stop the RFID scanning.

In step S120, the reading control section 73 makes a determination as to whether a barcode is presently being scanned. If a barcode is presently being scanned, the result of the determination in step S120 is affirmative and the processing advances to step S123. On the other hand, if no barcode is presently being scanned, the result of the determination in step S120 is negative and the processing advances to step S121.

In step S121, the selection section 72 sets two-dimensional code scanning as the reading system. Then the reading control section 73 controls the code scanner unit 13 to start two-dimensional code scanning.

In step S122, the sound output control section 74 outputs an eighth buzzer sound. In this processing, the eighth buzzer sound is outputted when the reading system is changed from the system that reads barcodes with the code scanner unit 13 to the system that reads two-dimensional codes. That is, the eighth buzzer sound is outputted when a different reading system from previously is selected.

The eighth buzzer sound is a sound from which an operator may recognize that a different reading system from before has been selected. When the operator hears the eighth buzzer sound, the operator may understand that the reading system has changed from the system that reads barcodes with the code scanner unit 13 to the system that reads two-dimensional codes.

In step S123, the reading control section 73 makes a determination as to whether a two-dimensional code is presently being scanned. If a two-dimensional code is presently being scanned, the result of the determination in step S123 is affirmative and the processing advances to step S126. On the other hand, if no two-dimensional code is presently being scanned, the result of the determination in step S123 is negative and the processing advances to step S124.

In step S124, the selection section 72 sets two-dimensional code scanning as the reading system. Then the reading control section 73 controls the code scanner unit 13 to start two-dimensional code scanning.

In step S125, the sound output control section 74 outputs a ninth buzzer sound. In this processing, the ninth buzzer sound is outputted when the reading system is changed from the system that reads RFID tags with the RFID reader/writer unit 14 to the system that reads two-dimensional codes with the code scanner unit 13. That is, the ninth buzzer sound is outputted when a different reading system from previously is selected.

The ninth buzzer sound is a sound from which an operator may recognize that a different reading system from before has been selected. When the operator hears the ninth buzzer sound, the operator may understand that the reading system has changed from the system that reads RFID tags with the RFID reader/writer unit 14 to the system that reads two-dimensional codes with the code scanner unit 13. The ninth buzzer sound may be a sound with the same composition as the eighth buzzer sound.

In step S126, the reading control section 73 makes a determination as to whether a two-dimensional code scan has succeeded. If the two-dimensional code scan has succeeded, the result of the determination in step S126 is affirmative, and the reading processing ends with the reading as a success. On the other hand, if the two-dimensional code scan has failed, the result of the determination in step S126 is negative, and the reading processing ends with the reading as a failure.

As is described hereabove, the selection section 72 of the information processing device 1 according to the third embodiment selects, in accordance with an inclination of the device body 10 detected by the inclination detection section, one reading system from plural reading systems, including at least RFID scanning that reads RFID tags, barcode scanning that reads barcode tags, which are one-dimensional codes, and two-dimensional code scanning that reads two-dimensional codes. Then the reading control section 73 implements control of reading of RFID tags, barcodes or two-dimensional codes with the reading system selected by the selection section 72.

An operator may select any recording system from RFID scanning, barcode scanning and two-dimensional code scanning simply by inclining the device body in accordance with a type of identifier. Therefore, the operator may easily perform reading of identifiers irrespective of the form of attached identifiers simply by looking at the identifiers attached to objects and tilting their wrist. Thus, reading operations may be carried out without the operator having to check a separate switching control when selecting a reading system, and the efficiency of operator operations may be improved.

Here above, the information processing device 1 is described in accordance with the third embodiment of the present invention.

Next, the information processing device 1 is described in accordance with a fourth embodiment of the present invention.

### Fourth Embodiment

The information processing device 1 according to the fourth embodiment of the present invention may assume basically the same hardware structure and functional structure as the information processing device 1 according to the first embodiment.

Therefore, FIG. 3 is also usable as a block diagram showing hardware structures of the image processing device 1 in accordance with the fourth embodiment.

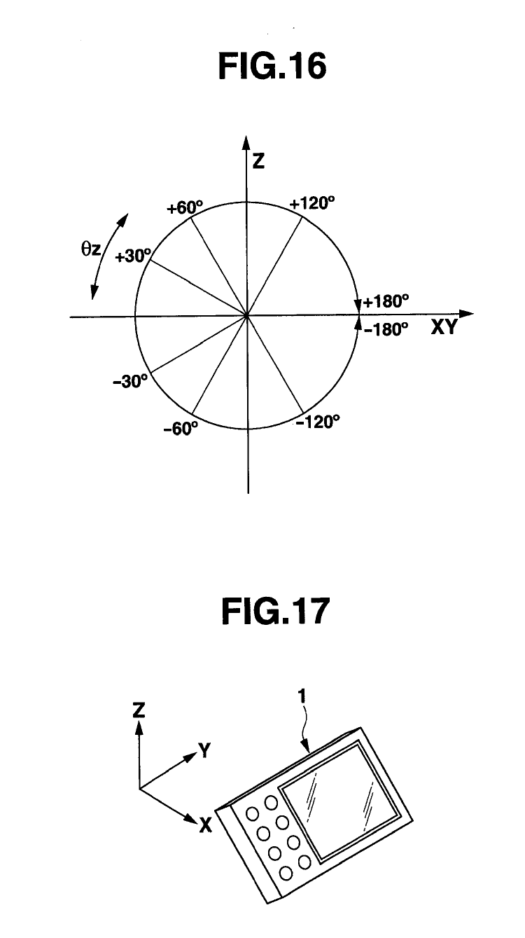

However, the present embodiment differs in that, in the reading processing of FIG. 9 in the first embodiment, either barcode scanning or RFID scanning starts in accordance with an inclination detected by the inclination detection section 36, but in the fourth embodiment, at predetermined inclinations of the inclination detected by the inclination detection section 36, neither barcode scanning nor RFID scanning starts. Characteristics of the fourth embodiment are described with reference to FIG. 16 and FIG. 17.

FIG. 16 is a side diagram showing inclinations of the device body 10 structuring the information processing device 1 of FIG. 1.

In the fourth embodiment, a state in which the device body 10 is held with the turning angle thetaZ of the device body 10 about the Y-axis within a range from −30° to +30°, as shown in FIG. 16, is specified as a first state. When the device body 10 is in the first state and the operation section (see FIG. 3) is pressed to instruct the start of scanning processing, the selection section 72 selects the code scanning system, and transfers the result of this selection to the reading control section 73 and the sound output control section 74.

A state in which the device body 10 is held with the turning angle thetaZ of the device body 10 about the Y-axis within a range from −120° to −60° or from +60° to +120° is specified as a second state. When the device body 10 is in the second state and the operation section (see FIG. 3) is pressed to instruct the start of scanning processing, the selection section 72 selects the RFID scanning system, and transfers the result of this selection to the reading control section 73 and the sound output control section 74.

A state in which the device body 10 is held with the turning angle thetaZ of the device body 10 about the Y-axis within a range from −180° to −120°, from −60° to −30°, from +30° to +60° or from +120° to +180° is specified as a third state. When the device body 10 is in the third state, even if the operation section (see FIG. 3) is pressed to instruct the start of scanning processing, the selection section 72 does not select any scanning system, and transfers this information to the reading control section 73 and the sound output control section 74. When the reading control section 73 receives this information, the reading control section 73 stops any scanning.

The ranges of the third state in which the turning angle thetaZ is from −180° to −120°, −60° to −30°, +30° to +60° or +120° to +180° are referred to hereinafter as “dead zones”.

FIG. 17 is a view showing a state in which the device body 10 structuring the information processing device 1 of FIG. 1 is being tilted from the first state to the second state.

When being tilted from the first state in which scanning is performed by the code scanning system to the second state in which scanning is performed by the RFID scanning system (or vice versa), as shown in FIG. 17, the device body 10 of the information processing device 1 passes through the third state (a dead zone) in which neither scanning system is selected.

Thus, because the dead zones in which scanning by neither scanning system is performed are provided in the course of switching of a scanning state from the first state to the second state, scanning misoperations due to shaky hands may be prevented even while rapid operation switching responses are realized.

The scanning processing that is executed by the information processing device 1 according to the fourth embodiment basically has the same flow as the scanning processing according to the first embodiment. Therefore, FIG. 8 is also usable as a flowchart describing a flow of the scanning processing according to the fourth embodiment.

Moreover, the reading processing that is executed by the information processing device 1 according to the fourth embodiment basically has the same flow as the reading processing according to the first embodiment. Therefore, FIG. 9 is also usable as a flowchart describing a flow of the reading processing according to the fourth embodiment.

However, while one of barcode scanning and RFID scanning is started in accordance with any inclination detected by the inclination detection section 36 in the first embodiment, the fourth embodiment differs in that the dead zones, at which neither scanning is performed, are provided at predetermined inclinations of the inclination detected by the inclination detection section 36.

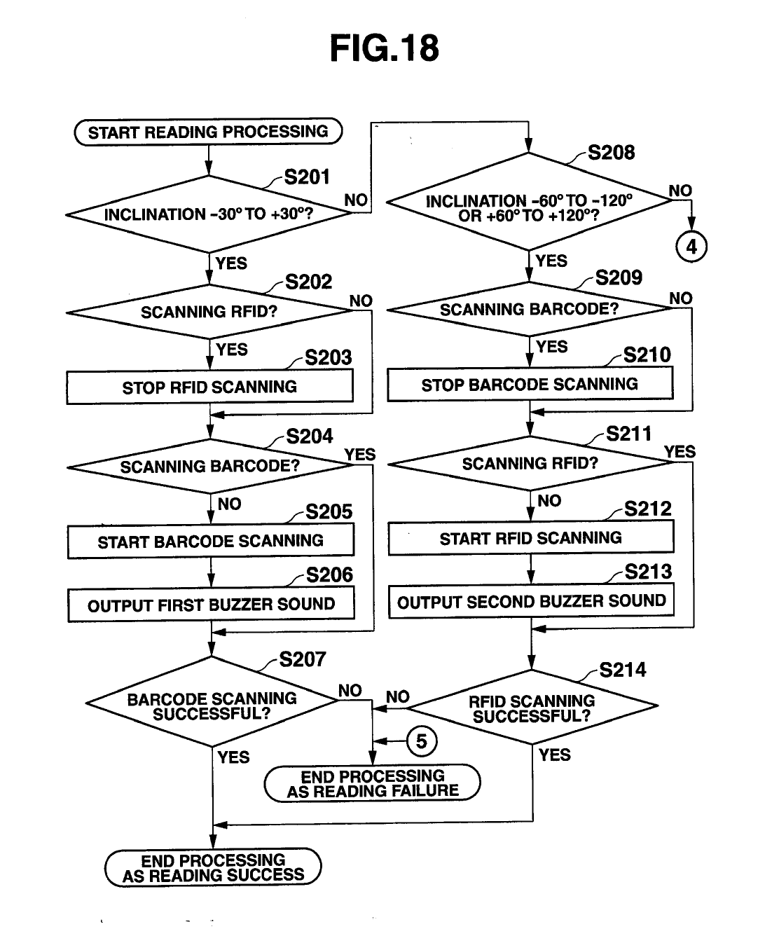

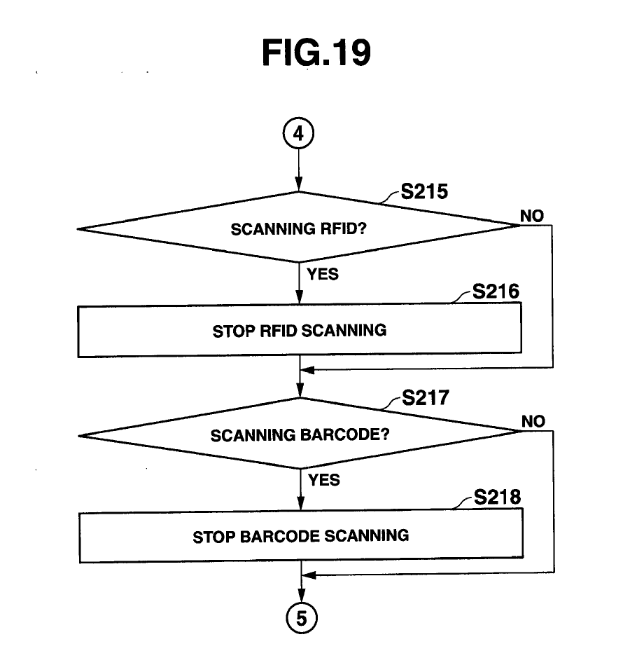

Therefore, for the reading processing of the fourth embodiment, the flowchart of FIG. 18 and FIG. 19 is employed instead of the flowchart of FIG. 9 that is employed in the first embodiment.

FIG. 18 and FIG. 19 are a flowchart describing the flow of reading processing in accordance with the fourth embodiment, which is executed by the information processing device 1 of FIG. 3 equipped with the functional structures according to FIG. 7.

In the first embodiment of the reading processing in FIG. 9 described above, barcode scanning or RFID scanning starts in accordance with the inclination detected by the inclination detection section 36. In contrast, the fourth embodiment of the reading processing differs in that no scanning is performed if the detected inclination is in the dead zone range.

Accordingly, the following descriptions mainly describe this difference, and descriptions of similarities are omitted as appropriate.

In step S201, the selection section 72 makes a determination as to whether an inclination detected by the inclination detection section 36, that is, the turning angle thetaZ about the Y-axis, is in the range from −30° to +30°. If the inclination is in the range from −30° to +30°, the result of the determination in step S201 is affirmative and the processing advances to step S202. When the inclination is in the range from −30° to +30°, the selection section 72 selects the system for reading barcodes with the code scanner unit 13, and the following processing from step S202 to step S207 is carried out. The processing of steps S202 to S207 is the same as the processing of steps S42 to S47 of the first embodiment in FIG. 9, so is not described here.

If the inclination detected by the inclination detection section 36 is outside the range from −30° to +30°, the result of the determination in step S201 is negative and the processing advances to step S208.

In step S208, the selection section 72 makes a determination as to whether the inclination detected by the inclination detection section 36, that is, the turning angle thetaZ about the Y-axis, is in a range from −60° to −120° and from +60° to +120°. If the inclination is in the range from −60° to −120° and +60° to +120°, the result of the determination in step S208 is affirmative and the processing advances to step S209. When the inclination is in the range from −60° to −120° and +60° to +120°, the selection section 72 selects the system for reading RFID tags with the RFID reader/writer unit 14, and the following processing from step S209 to step S214 is carried out. The processing of steps S209 to S214 is the same as the processing of steps S48 to S53 of the first embodiment in FIG. 9, so is not described here.

If the inclination detected by the inclination detection section 36 is outside the range from −60° to −120° and +60° to +120°, the result of the determination in step S208 is negative and the processing advances to step S215 of FIG. 19.

In step S215, the reading control section 73 makes a determination as to whether an RFID is presently being scanned. If no RFID is presently being scanned, the result of the determination in step S215 is negative and the processing advances to step S217. On the other hand, if an RFID is presently being scanned, the result of the determination in step S215 is affirmative and the processing advances to step S216.

In step S216, the reading control section 73 controls the RFID reader/writer unit 14 to stop the RFID scanning.

In step S217, the reading control section 73 makes a determination as to whether a barcode is presently being scanned. If no barcode is presently being scanned, the result of the determination in step S217 is negative and the reading processing ends with the reading as a failure. On the other hand, if a barcode is presently being scanned, the result of the determination in step S217 is affirmative and the processing advances to step S218.

In step S218, the reading control section 73 controls the code scanner unit 13 to stop the barcode scanning. When this processing is completed, the reading processing ends with the reading as a failure.

As is described hereabove, the selection section 72 of the information processing device 1 according to the fourth embodiment does not select either of the systems for reading barcodes or RFID tags with the code scanner unit 13 or RFID reader/writer unit 14 at predetermined inclinations, of the inclination of the device body 10 detected by the inclination detection section 36, where the reading system is changing from barcode scanning to RFID scanning or vice versa.

Thus, because the dead zones are provided such that scanning by any scanning system is stopped at predetermined inclinations when the scanning system is being changed, even if the inclination of the information processing device 1 is inconsistent because of hand shaking or the like, unintended scanning misoperations are prevented and operations may be performed more reliably.

It should be noted that the present invention is not limited to the embodiments described above, and any modifications and improvements thereto within a scope that can realize the object of the present invention are included in the present invention.

In the embodiments described above, the selection section 72 selects a system for reading with the code scanner unit 13 or the RFID reader/writer unit 14 depending on whether or not the turning angle thetaZ of the device body 10 about the Y-axis is in the range from −45° to +45°, but this is not limiting. For example, the selection section 72 may select a reading system in accordance with a turning angle of the device body 10 about the X-axis, about the Z-axis, about an XY axis, about a YZ axis or about an XZ axis.

Further, an inversion switch, which is not shown in the drawings, may be provided at the operation section 12 of the information processing device 1. When this inversion switch is operated by an operator, the selection section 72 may select different (opposite) reading systems to the reading systems that are selected at usual times.

In the embodiment described above, an example in which the information processing device 1 in which the present invention is employed is a handy terminal is described as an example, but this is not a particular limitation.

For example, the present invention may be generally applied to electronic devices with reading functions that read identifiers. As specific examples, the present invention is applicable to notebook computers, printers, television sets, video cameras, digital cameras, portable navigation devices, portable telephones, portable video game machines and so forth.

The processing sequence described above can be executed by hardware, and also can be executed by software.

In other words, the functional configuration shown in FIG. 7 is merely an illustrative example, and the present invention is not particularly limited thereto. In other words, it is sufficient that a function capable of executing the whole of the above-described sequence of processing is provided at the information processing device 1; the kinds of functional blocks to be used for executing this function are not particularly limited by the example in FIG. 7.

A single functional block may be configured by a single piece of hardware, a single installation of software, or any combination thereof.

In a case in which the processing sequence is to be executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

As well as the removable medium 61 in FIG. 1 that is distributed separately from the body of the equipment for supplying the program to users, a storage medium containing such a program may be constituted by a storage medium that is supplied to users in a state of being pre-incorporated in the body of the equipment. The removable medium 61 is constituted by, for example, a magnetic disc (such as a floppy disk), an optical disc, a magneto-optical disc or the like. The optical disk is composed of a CD-ROM (Compact Disc-Read Only Memory), a DVD (Digital Versatile Disc), or the like, for example. The magneto-optical disk is composed of an MD (Mini-Disk) or the like. A recording medium that is supplied to users in a state of being incorporated in the body of the equipment is constituted by, for example, the ROM 32 of FIG. 3, in which the program is stored, a hard disc included in the storage section 37, or the like.

It should be noted that the steps in the present specification describing the program recorded in the storage medium include not only processing executed in a time series following this order, but also processing that is not necessarily executed in a time series but is executed in parallel or individually.

Moreover, the term “system” as used in the present specification is intended to include the whole of equipment constituted by plural devices, plural units and the like.

A number of embodiments of the present invention are explained hereabove. These embodiments are merely examples and do not limit the technical scope of the invention. The present invention may be attained by numerous other embodiments, and numerous modifications such as omissions, substitutions and the like are possible within a technical scope not departing from the spirit of the invention. These embodiments and modifications are to be encompassed by the scope and gist of the invention recited in the present specification, etc., and are encompassed by the inventions recited in the attached claims and their equivalents.

1. An information processing device comprising:
a plurality of reading units provided to be capable of reading each of a plurality of types of identifier that differ in reading systems;
an inclination detection section that detects an inclination of a body of the device;
a selection section that selects one reading unit from the plurality of reading units in accordance with the inclination of the device body detected by the inclination detection section;
a control section that causes identifiers of one type to be read by the reading unit selected by the selection section; and
a processing section that processes information of the identifiers read by the reading unit.

2. The information processing device according to claim 1, wherein the control section causes a plurality of the identifiers to be read by one of a single scanning system that singly reads the plurality of identifiers respectively individually, and a batch scanning system that reads the plurality of identifiers as a batch.

3. The information processing device according to claim 1, wherein each reading unit reads at least one type of identifier of a plurality of types of identifier including RFID tags, one-dimensional codes and two-dimensional codes.

4. The information processing device according to claim 1, wherein, when the inclination of the device body detected by the inclination detection section is a predetermined inclination, the selection section does not change the reading unit.

5. The information processing device according to claim 1, further comprising a notification section that gives notice of a change of reading unit when a different reading unit from previously is selected by the selection section.

6. An information processing method comprising:
an inclination detection step of detecting an inclination of a body of a device;
a selection step of selecting one reading unit from a plurality of reading units, which are provided to be capable of reading each of a plurality of types of identifier that differ in reading systems, in accordance with the inclination of the device body detected by the inclination detection step;
a control step of causing identifiers of one type to be read by the reading unit selected by the selection step; and
a processing step of processing information of the identifiers read by the reading unit.

7. A non-transitory computer readable medium having stored therein a program executable by a computer for causing the computer to execute a process comprising:
detecting an inclination of a body of a device;
selecting one reading unit from a plurality of reading units, which are provided to be capable of reading each of a plurality of types of identifier that differ in reading systems, in accordance with the detected inclination of the device body;
causing identifiers of one type to be read by the selected reading unit; and
processing information of the identifiers that are read.

8. The information processing device according claim 2, wherein, when the inclination of the device body detected by the inclination detection section is a predetermined inclination, the selection section does not change the reading unit.

9. The information processing device according to claim 3, wherein, when the inclination of the device body detected by the inclination detection section is a predetermined inclination, the selection section does not change the reading unit.

10. The information processing device according to claim 2, further comprising a notification section that gives notice of a change of reading unit when a different reading unit from previously is selected by the selection section.

11. The information processing device according to claim 3, further comprising a notification section that gives notice of a change of reading unit when a different reading unit from previously is selected by the selection section.

12. The information processing device according to claim 4, further comprising a notification section that gives notice of a change of reading unit when a different reading unit from previously is selected by the selection section.

13. The information processing device according to claim 8, further comprising a notification section that gives notice of a change of reading unit when a different reading unit from previously is selected by the selection section.

14. The information processing device according to claim 9, further comprising a notification section that gives notice of a change of reading unit when a different reading unit from previously is selected by the selection section.
